(19) United States
(12) Patent Application Publication
(10) Pub. No.: US 2015/0086799 A1
(43) Pub. Date: Mar. 26, 2015

(54) ORGANIC POLYMER COMPOUNDS SUITABLE FOR FORMING POSITIVE A-TYPE RETARDERS AND METHODS OF PRODUCTION THEREOF

(71) Applicant: Light Polymers Holding, George Town (KY)

(72) Inventors: Irina Kasyanova, South San Francisco, CA (US); Evgeni Poliakov, South San Francisco, CA (US); Valery Kuzmin, South San Francisco, CA (US); Mary Parent, South San Francisco, CA (US)

(73) Assignee: LIGHT POLYMERS HOLDING, George Town (KY)

(21) Appl. No.: 14/033,415

(22) Filed: Sep. 20, 2013

(51) Int. Cl. G02B 1/04; C09D 177/10

(52) U.S. Cl. CPC G02B 1/04; C09D 177/10
USPC 428/474.4; 528/337; 524/606; 524/356; 524/391; 524/113; 524/173; 524/233; 524/108; 427/162; 427/506; 427/520

(57) ABSTRACT

An organic polymer solution may include about 0.1%-30% by weight of a specific polymer having rigid rod-like molecules. These molecules may include various cores, spacers, and sides groups to ensure their solubility, viscosity, and cross-linking ability. The rigid rod-like molecules are selected in such a way that they form self-assembling structures in the polymer solution, which makes it a lyotropic liquid crystal. The organic polymer solution, when properly deposited on a substrate and dried to remove solvents, forms a solid optical retardation layer of positive A-type substantially transparent to electromagnetic radiation in the visible spectral range.

### TECHNICAL FIELD

The present disclosure relates generally to organic polymers and, more particularly, to organic polymers having specific self-assembling (aligning) rod-like molecules, which polymers are suitable for forming retardation layers of positive A-type. The present disclosure also provides for various methods for producing such retardation layers and their applications.

### DESCRIPTION OF RELATED ART

Optical polymers have specific characteristics, such as relatively high and/or anisotropic refractive index, that make these polymers suitable for various optical applications. For example, glass-type, polymethylmethacrylate (PMMA), and polystyrene materials have been used as fiber optic core materials, backlight applications of liquid crystal displays (LCDs), plastic lenses, and films, while silicon resins and silica have been used as fiber claddings. However, the refractive index of PMMA is about 1.49, while the refractive index of polystyrene is about 1.59. These values may not be sufficient to harness the light, and many researches strive to develop polymers with higher refractive index values to reduce working distances and achieve better geometry of optical elements by invoking “faster (high-refractive index) optics.” Another example application are LCDs, which utilize optically anisotropic birefringent films, particularly in polarizing stacks, or achieving programmable retardation in three-dimensional applications. Such polymer films may be made from various polymer materials that may acquire optical anisotropy through uniaxial or biaxial intrinsic birefringence of material refractive indexes or their extension through polymer alignment techniques. For example, triacetyl cellulose (TAC) may be used as weak negative C plates with low intrinsic values of birefringence. Another example is making retardation films from cyclo olefin polymer (COP) by stretching. Other examples for producing optical elements may also include the use of polycarbonate, PMMA, and polyamide. These polymers may be used as orientation films or light guides in LCDs or other optical devices. Polyethylene terephthalate (PET) and poly carbonate (PC) based optical elements may have very high intrinsic birefringence, which makes them difficult substrates to stretch to make a stretched retarder similar to TAC unless special alignment techniques are applied. Furthermore, new and inexpensive yet controlled processing techniques are highly desirable. Many existing polymers are difficult to process, and some processing techniques may negatively impact optical characteristics of polymers. For example, using temperature gradients makes thermo-tropic crystals, also used as retarders; however, the alignment is done in predetermined fashion by rubbing polyamide structures in certain direction, thereby adding processing cost and manufacturing steps. It becomes even more important since screen size is continuously growing, and stretched films of larger size are harder to process.

### SUMMARY

This summary is provided to introduce a selection of concepts in a simplified form that are further described in the Detailed Description below. This summary is not intended to identify key features or essential features of the claimed subject matter, nor is it intended to be used as an aid in determining the scope of the claimed subject matter.

Provided are organic polymer compounds suitable to form various optical elements including positive A-type retarders or other similar optical elements. A solution of polymer compound may include between about 0.1% and 30% by weight of a specific polymer having rigid rod-like molecules. The molecules may include various cores, spacers, and side groups to ensure their solubility, viscosity, cross-linking ability, and other related processing properties. The rigid rod-like molecules may possess self-assembling or self-aligning properties thereby making the polymer a lyotropic liquid crystal or a like structure. The polymer solution, when deposited on a substrate and properly dried to remove solvents, may form a solid optical retardation layer having rigid rod-like molecules aligned substantially in a single direction. The retardation layer may be of positive A-type and be substantially transparent to electromagnetic radiation in the visible spectrum range. In addition, the retardation layer may have high refractive index values such as greater than 1.6 or even greater than 1.8 within a portion of the visible range. The retardation layers can be used, for example, in LCD active panels, light collimators, light guides in backlight stack applications, and so forth. Other applications, such as lenses and optical security films, are also within the scope of the present disclosure.

Deposition techniques of polymer solution may involve slot die coating, spray coating, molding at various temperatures, roll-to-roll coating, Mayer rod coating, extrusion, casting, embossing, and many more. Various pre-deposition and post-deposition techniques may be employed. At least some pre-deposition techniques may be employed to improve wettability and adhesion to a substrate on which the polymer solution is deposited. Some examples of pre-deposition techniques may include saponification, cleaning, oxidizing, leaching, corona or plasma treatment, depositing a primer layer, and so forth. At least some post-deposition techniques may include ultraviolet (UV) radiation, infrared (IR) radiation, cross-linking of chemical compounds with a substrate, specific drying techniques, evaporation of solvent, treating with salt solutions, and structure-form shaping.

According to various aspects of the present disclosure, a polymer solution to be used to form retardation layers includes a solvent and a polymer. The polymer comprises n organic units having the following general structural formula

[-(Core(S)ₘ)ₖ-G₁-]ₙ

where the organic units comprise rigid conjugated organic component Core, wherein G is a spacer selected from the list comprising —C(O)—NR1-, —O—NR1-, linear and branched (C1-C4)alkylenes, —CR1R2-O—C(O)—CR1R2-, —C(O)—O—, —O—, —NR1-, where R1 and R2 are independently selected from the list comprising H, alkyl, alkenyl, alkinyl, aryl; wherein S are lyophilic side-groups providing solubility to the polymer in the solvent and which are the same or different and independently selected from the list comprising one or more of the following: —COOX, —SO₃X, wherein X is selected from the list comprising H, alkyl, alkenyl, alkinyl, aryl, alkali metal, NW₄, where W is H or alkyl or any combination thereof, —SO₂NP1P2 and —CONP1P2, wherein P1 and P2 are independently selected from the list comprising H, alkyl, alkenyl, alkinyl, aryl; and where m is 0, 1, 2, or 3, and where k is 1, 2, or 3, and n is in the range of 10 and 10,000 or even more. The number n provides a molecule anisotropy that promotes self-assembling of macromolecules in a solution of the polymer, thereby forming a lyotropic liquid crystal. It is important that the solution is capable of forming a solid optical retardation layer of positive A-type substantially transparent to electromagnetic radiation in the visible spectral range.

The solvent may comprise one or more of the following: polar protic solvent, polar aprotic solvent, and non-polar solvent. More specifically, the solvent may comprise one or more of the following: water, ketones, alcohols, hydroxyketones, tetrahydrofuran (THF), methyl acetate (MA), and MIBK. In various embodiments, the polymer solution may include one or more additives such as nonylphenoxypoly glycidol, alcohols, acids, plasticizing agents, surfactants, stabilizers, antioxidants, and hindered phenol. In further example embodiments of the present disclosure, the method steps may be implemented using various systems, devices, and mechanisms. In certain embodiments, these n organic units may be terminated with any suitable UV-curable elements such as alkenyl, alkynyl, acrylic, and the like. Cores, spacers and S-groups can selected independently. Other features, examples, and embodiments are described below.

### BRIEF DESCRIPTION OF THE DRAWINGS

Embodiments are illustrated by way of example, and not by limitation, in the figures of the accompanying drawings, in which like references indicate similar elements and in which:

FIG. 1 is a high level illustration of a coordinate system associated with an optical element.

FIG. 2 is a high level illustration of rigid rod-like polymer molecules (chains) and their orientation within an optical element.

FIG. 3 is a high level illustration showing a substrate having one surface coated with a polymer film.

FIG. 4 shows a schematic illustration of a method for depositing a water-based polymer solution on a substrate, in accordance with various embodiments of the present disclosure.

FIG. 5 illustrates an exemplary slot die deposition technique that includes an embosser roll.

FIG. 6A shows example dry thickness dependency against wet thickness for a polymer solution deposited onto a substrate.

FIG. 6B shows example in-plane retardation dependency against dry thickness for a polymer solution deposited onto a substrate.

FIG. 7 shows measured dependencies of viscosity (cP) as a function of shear rate (s⁻¹) for different polymer concentrations (N).

FIGS. 8A-8C show example molding operations to form an optical element.

FIGS. 9A, 9B show an example grooving process of polymer solution layer deposited onto a substrate.

FIG. 10 illustrates an example schematic cross-sectional view of an example display system.

FIG. 11 illustrates an example schematic cross-sectional view of an example display system stack.

FIG. 12 illustrates an optimization plot (map) for the example display system stack of FIG. 11.

FIG. 13 illustrates a viewing angle contrast ratio map in the case of optimized design in accordance with the optimization plot shown in FIG. 12.

FIG. 14 illustrates the same viewing angle contrast ratio map as in FIG. 13, but for a higher contrast ratio.

FIG. 15 illustrates adhesion of a polymer solution deposited onto a substrate.

### DETAILED DESCRIPTION

In the following description, numerous specific details are set forth in order to provide a thorough understanding of the presented concepts. The presented concepts may be practiced without some or all of these specific details. In other instances, well known process operations have not been described in detail so as to not unnecessarily obscure the described concepts. While some concepts will be described in conjunction with the specific embodiments, it will be understood that these embodiments are not intended to be limiting.

### INTRODUCTION

Organic polymers can be used to fabricate various optical elements including plastic optical fibers, optical coatings, lenses, retarders, polarizers, light collimators, light guides, optical films (diffusers, collimating structures, light enhancement films, anti-glare and anti-reflection structures), illuminators, and many other types of devices. However, such applications require specific optical characteristics and, in many cases, specific processing characteristics, and very few polymers have sufficiently high values of refractive index and/or birefringence. For example, optically anisotropic birefringent films may be used in LCDs or other backlight stack applications such as retarders, optical films, collimators, optical films, illuminators, light boxes, light guides, light collimators, and so forth. These films may be optimized for the optical characteristics of each individual LCD type. In particular, retarders may be needed to enhance the viewing angle contrast ratio for LCD applications. The films may acquire optical anisotropy through uniaxial and biaxial extension, shear stresses exerted on the polymers, casting and molding, and other suitable techniques.

According to embodiments of the present disclosure, organic polymers described herein may be used to fabricate positive A-type retarders for LCDs or other optical elements. Conventional retarders are made by stretching polymer films to achieve certain characteristics. Stretching introduces various stresses and damages into these conventional films and negatively affects their performance. In addition, it may be difficult to stretch in two orthogonal directions (often required to obtain the necessary performance for a LCD stack). Larger display formats introduce another degree of complexity and quality requirements. The methods described herein deposit different kinds of optical films that do not need to be stretched or thermo-processed to achieve orientation and, as a result, are substantially free from stresses and damages when integrated into an optical element, such as an LCD. In contrast to conventional methods, orientation of polymer molecules in these films may be achieved during the deposit process as the molecules are aligned by shear stresses.

According to various embodiments, polymer solutions to fabricate positive A-type retarders may include between about 0.1% and 30% or even between 1% and 10% by weight of a specific polymer having rigid rod-like molecules. Solvents used in the polymer solution may include a wide range of substances such as polar protic solvents, polar aprotic solvents, and non-polar solvents. The polymer molecules may have a chain length of between about 5,000 and 100,000 unified atomic mass units; however, it should be noted that optimal chain lengths and molecular weights in general may depend on polymer concentration in polymer solution, viscosity, temperature and many other chemical and physical parameters of deposition and post-deposition processes. The size of polymer chains allows aligning the polymer molecules at least in the coating direction so as to achieve desired refractive indices for the optical element. The rigid rod-like molecules of the polymer provide for molecule anisotropy which promotes self-assembling of polymer macromolecules, thereby forming a lyotropic liquid crystal. The polymer solution is capable of forming a solid optical retardation layer of positive A-type or a like structure substantially transparent to electromagnetic radiation in the visible spectral range.

The polymer solution may be deposited using a wide range of the following techniques: slot die, spraying, molding, roll-to-roll coating, Mayer rod coating, roll coating, gravure coating, micro-gravure coating, comma coating, knife coating, extrusion, printing, dip coating, and so forth. For example, a slot die technique may involve forcing under pressure a polymer solution from a reservoir through a slot onto a moving substrate. The slot may have a much smaller cross-section than the reservoir and may be oriented perpendicularly to the direction of the substrate movement. The combination of the pressure, size of the slot width, gap between the slot and the substrate, and substrate moving speed as well as various polymer solution characteristics described above provide for specific orientation of the molecules (e.g., these parameters may define characteristics of a positive A retarders).

Substrates used for polymer solution deposition may be also selected from a wide range of suitable materials including, for example, glass substrate, TAC substrate, polypropylene substrate, polycarbonate substrate, PET, polyacrylic substrate, PMMA substrate, other plastic substrate, and so forth. The substrates may be treated using one or more techniques prior to deposition of the polymer solution so as to improve wettability and/or adhesion of the polymer solution deposited onto the substrate. In particular, the treating techniques may include one or more of the following: cleaning (e.g., ultrasound cleaning), leaching and/or oxidizing using mildly alkaline water solution, saponification, depositing a primer layer (e.g., silane or polyethyleneimine), and modifying surface relief and/or surface free energy of the substrate by subjecting it to corona discharge or plasma discharge utilizing various gases and vapors, or electron or ion beams. The pre-deposition techniques may also include an addition of additives to the polymer solutions. The additives may include plasticizing agents, antioxidants, surfactants, formability agents, stabilizers, nonylphenoxypoly glycidol, alcohols, acids, and hindered phenol or other low molecular weight materials and polymers.

In general, the polymer solutions may be isotropic prior to deposition and have no preferred direction for molecule orientation. However, various post-deposition techniques may be employed to achieve desired orientation of the molecules or specific optical properties. Post-deposition techniques may include, for example, slot-die coating, knife-coating, Mayer-rod, or another pressure-oriented techniques, with further possible modifications, which can incorporate but not limited to UV cross-linking, specific drying techniques, techniques to evaporate solvents from polymer solutions, IR light radiation, heating, subjecting to a drying gas flow, shaping, and so forth.

The specifically designed polymers and deposition processes may yield optical elements with high refractive index values along certain directions (for example, greater than 1.6 or even greater than 1.7 within a portion of the visible light range). As already noted above, these optical elements may refer to positive A-type retarders (plates) for LCD active panels, light collimators, light guides, or other optical application. Other applications, such as lenses and optical security films, are also within the scope of the present disclosure.

### DEFINITIONS

The term a “visible spectral range” refers to a spectral range having a lower boundary of approximately 400 nm and an upper boundary of approximately 700 nm.

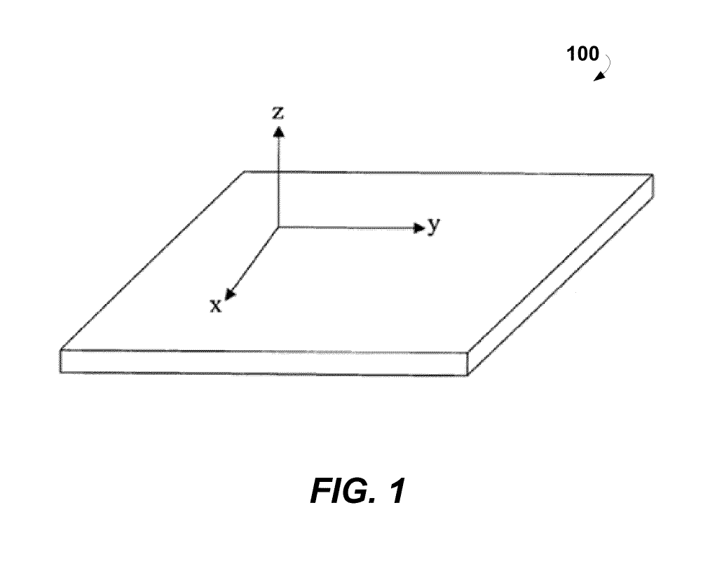

The terms “retardation layer,” “retarder,” or “plate” refer to an optically anisotropic layer, which can alter the polarization state of a light wave traveling through the anisotropic layer and which is characterized by three principal refractive indices (nₓ, n_{y}, and n_{z}) associated with a Cartesian coordinate system related to the deposited polymer solution layer or the corresponding optical element based thereupon. Two principal directions for refractive indices nₓ and n_{y} may belong to the xy-plane coinciding with a plane of the retardation layer, while one principal direction for refractive index (n_{z}) coincides with a normal line to the retardation layer. This is further illustrated in FIG. 1, which shows an optical element 100 (e.g., A-type retarder) including a dried polymer solution layer (which may be optionally deposited onto a substrate) and an axis system (e.g., Cartesian coordinate system) having orthogonal axes x, y, and z. In various embodiments, at least two refractive indices among nₓ, n_{y}, and n_{z} have different values. The term “retardation layer” and “retarder” may also refer to an optical element that divides an incident monochromatic polarized light into components and introduces a relative retardance or phase shift between them.

The term “biaxial retardation layer” refers to an optical layer which has refractive indices nₓ, n_{y}, and n_{z} satisfying the following condition in the visible spectral range: nₓ≠n_{z}, nₓ≠n_{y}, and n_{y}≠n_{z}.

The term “uniaxial retardation layer” refers to an optical layer with refractive indices satisfying the following condition in the visible spectral range: nₓ=n_{y}≠n_{z}, or nₓ≠n_{y}=n_{z}, or nₓ=n_{z}≠n_{y}.

The term “optically anisotropic retardation layer of Ac-plate type” refers to an optical layer in which refractive indices nₓ, n_{y}, and n_{z} obey the following condition in the visible spectral range: n_{z}<n_{y}<nₓ.

The term “optically anisotropic retardation layer of negative C-plate type” refers to an optical layer with refractive indices nₓ, n_{y}, and n_{z} satisfying the following condition in the visible spectral range: n_{z}<nₓ=n_{y}.

The above definitions are invariant to rotation of the system of coordinates (of the laboratory frame) about the vertical z-axis for all types of anisotropic layers.

The terms “A-type retardation layer,” “A-type retarder,” or simply “A-plate,” denote a birefringent optical element, such as, for example, a plate or film, having its principle optical axis within the x-y plane of the optical element. Positively birefringent A-plates can be fabricated using, for example, uniaxially stretched films of polymers such as, for example, polyvinyl alcohol, polynorbornene or polycarbonate, or uniaxially aligned films of nematic positive optical anisotropy liquid crystal polymer (LCP) materials. Negatively birefringent A-plates can be formed using uniaxially aligned films of negative optical anisotropy nematic LCP materials, including for example discotic compounds.

The terms “C-type retardation layer” or “C-plate” may refer to a birefringent optical element, such as, for example, a plate or film, with a principle optical axis (often referred to as the “extraordinary axis”) substantially perpendicular to the selected surface of the optical element. The principle optical axis corresponds to the axis along which the birefringent optical element has an index of refraction different from the substantially uniform index of refraction along directions normal to the principle optical axis (for example, a C-plate using the axis system illustrated in FIG. 1 with nₓ=n_{y}≠n_{z}, where nₓ, n_{y}, and n_{z} are the indices of refraction along the x, y, and z axes, respectively). The optical anisotropy is defined as Δn_{zx}=n_{z}−nₓ. For purposes of simplicity, Δn_{zx} will be reported as its absolute value.

The term “polymer” should be understood to include polymers, copolymers (e.g., polymers formed using two or more different types of monomers), oligomers and combinations thereof, as well as polymers, oligomers, or copolymers that can be formed in a miscible blend by, for example, co-extrusion or reaction, including transesterification, i.e. the process of exchanging the organic group of an ester with the organic group of an alcohol. Both block and random copolymers are included, unless indicated otherwise.

The term “polarization” refers to plane polarization, circular polarization, elliptical polarization, or any other nonrandom polarization state in which the electric vector of the beam of light does not change direction randomly, but either maintains a constant orientation or varies in a systematic manner. In the plane polarization, the electric vector remains in a single plane, while in circular or elliptical polarization, the electric vector of the beam of light rotates in a systematic manner.

The term “retardation” or “retardance” refers to the difference between two orthogonal indices of refraction times the thickness of the optical element.

The term “in-plane retardation” refers to the product of the difference between two orthogonal in-plane indices of refraction times the thickness of the optical element.

The term “out-of-plane retardation” refers to the product of the difference of the index of refraction along the thickness direction (z direction) of the optical element minus one in-plane index of refraction times the thickness of the optical element. Alternatively, this term refers to the product of the difference of the index of refraction along the thickness direction (z direction) of the optical element minus the average of two orthogonal in-plane indices of refraction times the thickness of the optical element. It is understood that the sign—positive or negative—of the out-of-plane retardation is important to the user. But for purposes of simplicity, only the absolute value of the out-of-plane retardation will be reported herein. It is understood that one skilled in the art will know when to use an optical element with positive or negative out-of-plane retardation. For example, it is generally understood that an oriented film comprising triacetyl cellulose will produce a negative C-plate when the in-plane indices of refraction are substantially equal and the index of refraction in the thickness direction is less than the in-plane indices. However, herein, the value of the out-of-plane retardation will be reported as a positive number.

The term “substantially non-absorbing” refers to the level of transmission of the optical element of at least 80 percent transmissive with respect to at least one polarization state of visible light, where the percent transmission is normalized to the intensity of the incident, optionally polarized, light.

The term “substantially non-scattering” refers to the level of collimated or nearly collimated incident light that is transmitted through the optical element being at least 80 percent transmissive for at least one polarization state of visible light within a cone angle of less than 30 degrees.

The term “j-retarder” refers to a film or sheet that is substantially non-absorbing and non-scattering for at least one polarization state of visible light, where at least two of the three orthogonal indices of refraction are unequal, and where the in-plane retardation is no more than 100 nm and the absolute value of the out-of plane retardation is at least 50 nm.

All numeric values are herein assumed to be modified by the term “about,” whether or not explicitly indicated. The term “about” generally refers to a range of numbers that one of skill in the art would consider equivalent to the recited value (i.e., having the same function or result). In many instances, the terms “about” may include numbers that are rounded to the nearest significant figure.

Weight percent, percent by weight, % by weight, and the like are synonyms that refer to the concentration of a substance as the weight of that substance divided by the weight of the composition and multiplied by 100.

The recitation of numerical ranges by endpoints includes all numbers subsumed within that range (e.g. 1 to 5 includes 1, 1.5, 2, 2.75, 3, 3.80, 4, and 5).

As used in this specification and the appended claims, the singular forms “a,” “an,” and “the” include plural referents unless the content clearly dictates otherwise. Thus, for example, reference to a composition containing “a compound” includes a mixture of two or more compounds. As used in this specification and the appended claims, the term “or” is generally employed in its sense including “and/or” unless the content clearly dictates otherwise.

### Examples of Water Soluble Optical Polymers

Water soluble optical polymers that can be used to produce retarders or other optical elements may include a chain of n subunits, each subunit having a general structure formula (I) as follows:

[-(Core(S)ₘ)ₖ-G₁-]ₙ (I)

The number n of subunits may be between about 5 and 50,000 or, more specifically, between 10 and 10,000. Those skilled in the art should understand that the number of subunits may define physical properties of optical elements based thereupon. For example, when the number of subunits is relatively small, the corresponding polymer chains may be too short to achieve a desired self-assembly in a solution. On the other hand, when the number of subunits is relatively high, the corresponding polymer chains may be too long and cause high viscosity and poor dissolving qualities associated of the polymer solution. In this regard, the number of subunits and the corresponding chain length may depend on selected organic components (Core), spacers (G), side-groups (S), desired orientation, and particular application.

In various embodiments, the organic components (Core) provide linearity and rigidity of the macromolecule associated with the organic polymer compound having formula (I). The sets of lyophilic side groups (Sₘ) and the number of the organic units n may control both mesogenic properties and viscosity of the polymer solution. The selection of organic components (Core), the lyophilic side-groups (S), and number of organic subunits n may determine the type and birefringence of the optical film.

In some embodiments, the polymer may have one type of monomeric units and second type of monomeric units, where the ratios cover approximately 30 to 70% for either end and may go as low as few percent on either end.

Each subunit may include at least more than one of conjugated organic components (Core) capable of forming a rigid rod-like macromolecule. These conjugated components may be individually selected from the following list of structural formulas (II) to (X):

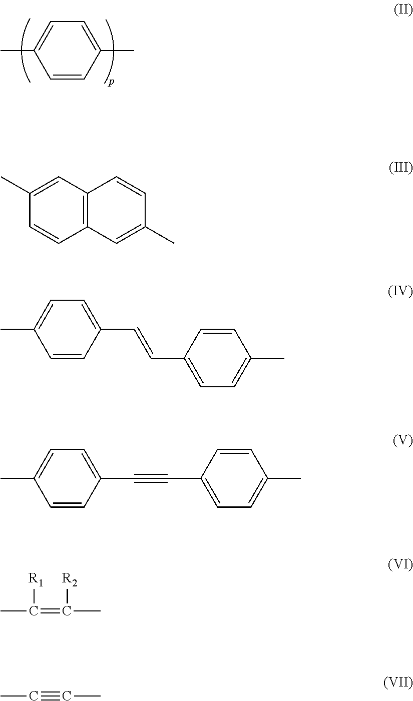

where p is an integer equal to 1, 2, 3, 4, 5, or 6; and where R1, R2=H, alkyl.

In certain embodiments, organic components (Core) in each subunit may be of the same type. Alternatively, each organic subunit may include a Core of different type which, in turn, may alter optical properties of optical elements including the polymer compound. Those skilled in the art should understand that combining the organic components in subunits may affect specific optical properties for the optical element.

Further, each subunit may also include one or more spacers (G). Some examples of spacers include —C(O)—NR1-, —O—NR1-, linear and branched (C1-C4)alkylenes, —CR1R2-O—C(O)—CR1R2-, —C(O)—O—, —O—, —NR1-, where R1 and R2 are independently selected from the list comprising H, alkyl, alkenyl, alkinyl, aryl.

Further, each subunit may also include one or more lyophilic side-groups (S), which may include lyophilic groups providing solubility to the polymer or its salts in a suitable solvent. In some embodiments, one or more side groups may be hydrophilic groups, such as —COOX, —SO₃X, wherein X is selected from the list comprising H, alkyl, alkenyl, alkinyl, aryl, alkali metal, NW4, wherein W is H or alkyl or any combination thereof, and —SO₂NP1P2 and —CONP1P2, where P1 and P2 are independently selected from the list comprising H, alkyl, alkenyl, alkinyl, aryl. In the formula (I), the total number of the side groups (m) is 0, 1, 2, or 3.

In various embodiments, said n organic units may include one or more termination components connecting to these n organic units according the following principle:

T-[-(Core(S)ₘ)ₖ-G₁-]ₙ-T (VIII)

where T includes one or more of alkenyl, alkynyl, acrylic or any other UV-curable group.

The number of side groups as well as the number of organic units n may control both mesogenic properties and viscosity of the polymer. The selection of organic components (Core), the side-groups (S) and number of organic units (i.e., the value of n) determines the type and birefringence of the polymers and corresponding optical element based on the polymers. These polymers may be capable of forming solid optical retardation layers, such as a positive A-type retardation layer, based on orientation of the polymers and its components. For example, the conjugated component having formula (II) is linear in general. Accordingly, if the subunit includes the conjugated components (II) only, the resulting polymer may have a positive A-type retardation layer.

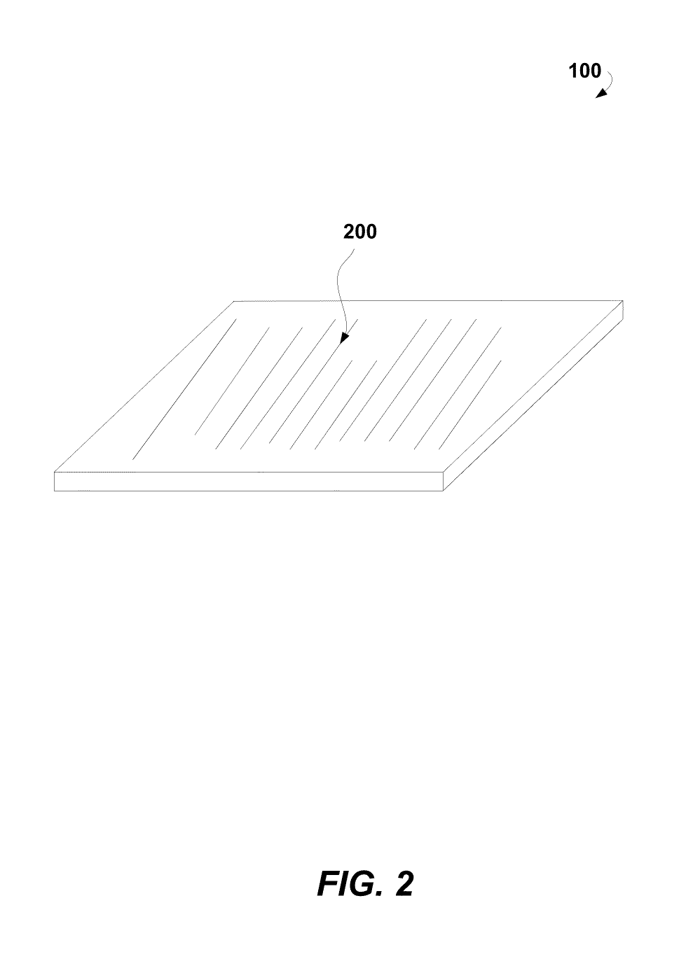

Molecules have to be rigid and long enough in order to provide self-assembly of rigid rod-like molecules of the polymer in a solution. This is a crucial aspect for forming lyotropic liquid crystal (LLC), which is important for creating positive A-type retarders. The selection of organic components (Core), the side-groups (S) and number of organic units (n) as well as selection of other elements as described herein may define an ordering of the rigid rod-like molecules of the polymer compound. Specifically, the ordering may involve self-assembling, or in other words, self-aligning, of the rigid rod-like molecules. FIG. 2 shows the optical element 100 (e.g., A-type retarder) which may include a dried polymer solution layer deposited on a transparent substrate. FIG. 2 also shows a special molecular order of rigid rod-like polymer molecules 200 or polymer chains, which are fairly oriented in substantially the same direction and substantially in parallel to the xy-plane. In various applications the orientation direction may not play any role, but in a case when the orientation is important, it may be defined by depositing, as described below. In other words, the processes involved into preparation of the retardation layer based on the polymer compound as described herein may be selected or adjusted in such a way there are achieved desired the self-assembling and orientation of rigid rod-like polymer molecules 200 in the optical element 100.

Further, in some embodiments, a polymer may have a specific number of organic compounds and spacers. In other words, a monomer subunit forming the polymer may include, for example, two organic components, one of which has no side groups, while the other has two side groups. The first organic component (Core) may be represented by any of the formulas above, i.e., II (where p=1), III (where p=1), V, VII and VIII. The second organic component (Core) may be represented by the general formula II (where p=2). The side-group (S) may include sulfo-group —SO₃H. The first spacer (G) may include C(O)—NH—, while the second spacer (G) may include one of —C(O)—, —NH—C(O)—. Examples of these subunits or polymers may include: poly(2,2′-disulfo-4,4′-benzidine terephthalamide), poly(para-phenylene sulfoterephthalamide), poly(2,2′-disulfo-4,4′-benzidine sulfoterephthalamide), poly(sulfo-para-phenylene sulfoterephthalamide), poly(2,2′-disulfo-4,4′-benzidine naphthalene-2,6-dicarboxamide), poly(2,2′-disulfo-4,4′-benzidine phthaloylamide), poly(2,2′-disulfo-stilbeneterephthalamide) and poly(1,1′:4′,1″-terphenyl-2,2′-disulfonic acid).

The corresponding structural formulas (IX)-(XVI) of these subunits are shown below:

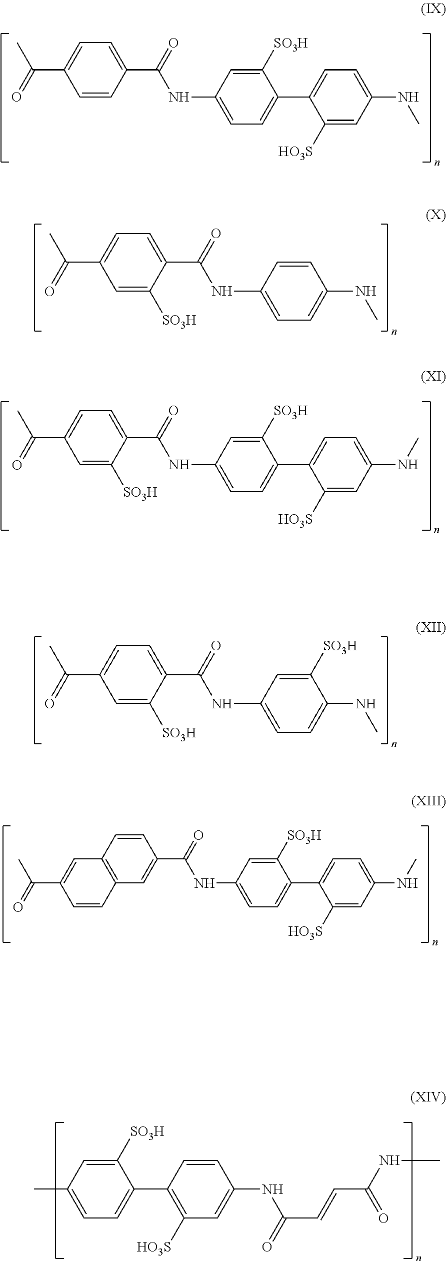

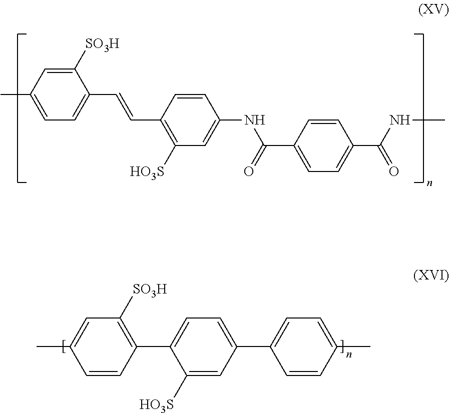

where the number n of subunits may be between about 5 and 500,000.

In various embodiments, one or more salts of the organic polymer solution may be used, such as alkaline metal salts, ammonium, alkyl-substituted ammonium salts, alkenyl-substituted ammonium salts, alkinyl-substituted ammonium salts, aryl-substituted ammonium salts.

In various embodiments, the polymer used for coating and/or the resulting polymer structure may include one or more inorganic compounds such as hydroxides and salts of alkaline metals.

Solvents used for dissolving polymers may include water, any organic solvent, or any combination thereof. In certain embodiments, the solvent may refer to polar protic solvent, polar aprotic solvent, or non-polar solvent. In yet other embodiments, the solvent may be selected from a group comprising: ketone, alcohol, tetrahydrofuran, ester, an alkaline aqueous solution, dimethylsulfoxide, dimethylformamide, dimethylacetamide, and dioxane.

### Examples of Synthesizing Polymers

Reference is now made to the following examples, which are intended to be illustrative of various embodiments of the present disclosure, but are not intended to be limiting of the scope.

### Example 1

This example describes synthesis of poly(2,2′-disulfo-4,4′-benzidine terephthalamide) (structure # IX) cesium salt.

1.377 g (0.004 mol) of 4,4′-diaminobiphenyl-2,2′-disulfonic acid was mixed with 1.2 g (0.008 mol) of CsOH and 40 ml of water and stirred with dispersing stirrer till dissolution. 0.672 g (0.008 mol) of sodium bicarbonate was added to the solution and stirred. While stirring the obtained solution at high speed (2500 rpm) the solution of 0.812 g (0.004 mol) of terephthaloyl dichloride in dried toluene (15 mL) was gradually added within 5 minutes. The stirring was continued for 5 more minutes, and viscous white emulsion was formed. Then the emulsion was diluted with 40 ml of water, and the stirring speed was reduced to 100 rpm. After the reaction mass has been homogenized the polymer was precipitated via adding 250 ml of acetone. Fibrous sediment was filtered and dried. Gel permeation chromatography (GPC) analysis of the sample was performed with Hewlett-Packard 1050 chromatograph with UV-VIS detector (λ=230 nm), using Varian GPC software Cirrus 3.2 and TOSOH Bioscience TSKgel G5000 PW_{XL} column and 0.2 M phosphate buffer (pH=7) as the mobile phase. Poly(para-styrenesulfonic acid) sodium salt was used as GPC standard. The number average molecular weight Mn, weight average molecular weight Mw, and polydispersity Pd were found as 3.9×10⁵, 1.7×10⁶, and 4.4 respectively.

### Example 2

This example describes synthesis of poly(2,2′-disulfo-4,4′-benzidine sulfoterephthalamide) (structure # XI). 10 g (40 mmol) of 2-sulfoterephtalic acid, 27.5 g (88.7 mmol) of triphenylphosphine, 20 g of LiCl and 50 ml of pyridine were dissolved in 200 ml of NMP in a 500 ml three-necked flask. The mixture was stirred at 40° C. for 15 min and then 13.77 g (40 mmol) of 4,4′-diaminobiphenyl-2,2′-disulfonic acid was added. The reaction mixture was stirred at 115° C. for 3 hours. 1 L of methanol was added to the viscous solution, formed yellow precipitate was filtrated and washed sequentially with methanol (500 ml) and diethyl ether (500 ml). Yellowish solid was dried in vacuo at 80° C. overnight. Molecular weight analysis of the sample via GPC was performed as described in Example 1.

10 g (40 mmol) of 2-sulfoterephtalic acid, 27.5 g (88.7 mmol) of triphenylphosphine, 20 g of LiCl and 50 ml of pyridine were dissolved in 200 ml of NMP in a 500 ml three-necked flask. The mixture was stirred at 40° C. for 15 min and then 13.77 g (40 mmol) of 4,4′-diaminobiphenyl-2,2′-disulfonic acid was added. The reaction mixture was stirred at 115° C. for 3 hours. 1 L of methanol was added to the viscous solution, formed yellow precipitate was filtrated and washed sequentially with methanol (500 ml) and diethyl ether (500 ml). Yellowish solid was dried in vacuo at 80° C. overnight. Molecular weight analysis of the sample via GPC was performed as described in Example 1.

### Example 3

This example describes synthesis of poly(para-phenylene sulfoterephthalamide) (structure # X).

10 g (40 mmol) of 2-sulfoterephtalic acid, 27.5 g (88.7 mmol) of triphenylphosphine, 20 g of LiCl and 50 ml of pyridine were dissolved in 200 ml of NMP in a 500 ml three-necked flask. The mixture was stirred at 40° C. for 15 min and then 4.35 g (40 mmol) of 1,4-phenylenediamine was added. The reaction mixture was stirred at 115° C. for 3 hours. 1 L of methanol was added to the viscous solution, formed yellow precipitate was filtrated and washed sequentially with methanol (500 ml) and diethyl ether (500 ml). Yellowish solid was dried in vacuo at 80° C. overnight. Molecular weight analysis of the sample via GPC was performed as described in Example 1.

### Example 4

This example describes synthesis of poly(2-sulfo-1,4-phenylene sulfoterephthalamide) (structure # XII).

10 g (40 mmol) of 2-sulfoterephtalic acid, 27.5 g (88.7 mmol) of triphenylphosphine, 20 g of LiCl and 50 ml of pyridine were dissolved in 200 ml of NMP in a 500 ml three-necked flask. The mixture was stirred at 40° C. for 15 min and then 7.52 g (40 mmol) of 2-sulfo-1,4-phenylenediamine was added. The reaction mixture was stirred at 115° C. for 3 hours. 1 L of methanol was added to the viscous solution, formed yellow precipitate was filtrated and washed sequentially with methanol (500 ml) and diethyl ether (500 ml). Yellowish solid was dried in vacuo at 80° C. overnight. Molecular weight analysis of the sample via GPC was performed as described in Example 1.

### Example 5

This example describes synthesis of poly(2,2′-disulfo-4,4′-benzidine naphthalene-2,6-dicarboxamide) cesium salt (structure # XIII).

0.344 g (0.001 mol) of 4,4′-diaminobiphenyl-2,2′-disulfonic acid was mixed with 0.3 g (0.002 mol) of CsOH and 10 ml of water and stirred with dispersing stirrer till dissolution. 0.168 g (0.002 mol) of sodium bicarbonate was added to the solution and stirred. While stirring the obtained solution at high speed (2500 rpm) the solution of 0.203 g (0.001 mol) of terephthaloyl dichloride in dried toluene (4 mL) was gradually added within 5 minutes. The stirring was continued for 5 more minutes, and viscous white emulsion was formed. Then the emulsion was diluted with 10 ml of water, and the stirring speed was reduced to 100 rpm. After the reaction mass has been homogenized the polymer was precipitated via adding 60 ml of acetone. The fibrous sediment was filtered and dried. Molecular weight analysis of the sample via GPC was performed as described in Example 1.

### Example 6

Example 6 describes a synthesis of UV-curable 2,2′-disulfo-4,4′-benzidine fumarylamide-phthalamide copolymer sodium salt.

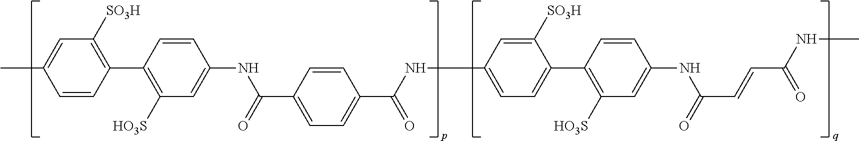

In particular, 15.0 g of 2,5-Diaminobenzene-1,4-disulfonic acid was mixed with 9.7 g of Sodium carbonate in 150 ml of water using a 2L beaker and stirred until the solid was completely dissolved. Further, 350 ml of toluene was added. Upon stirring the obtained solution at 7000 rpm, a solution of 3.7 g of Fymaryl chloride and 4.9 g of Phthaloyl chloride in toluene (350 ml) was added. The resulting mixture was stirred for 3 hrs. The stirrer was stopped, 600 ml of Acetone was added, and the thickened mixture was crushed with the stirrer to form slurry suitable for filtration. The polymer was filtered and washed twice with 350-ml portions of Acetone. The obtained polymer was dried at 75° C. The GPC molecular weight analysis of the sample was performed as described in Example 1.

### Example 7

Example 7 describes a synthesis of poly(1,1′:4′,1″-terphenyl-2,2′-disulfonic acid) sodium salt.

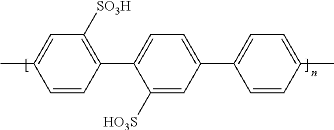

In particular, 15 g of 4,4′-dibromodiphenyl-2,2′-disulfonic acid was mixed with 100 ml of SOCl₂ and 1 ml of DMF and boiled for 8 hrs. Then SOCl₂ was evaporated and the product washed with Toluene. The obtained solid material was mixed with 170 ml of Toluene, 8.9g of 4-tert-Butylphenol and 8.2 ml of Triethylamine and the mixture was agitated at room temperature for 4 days. The reaction mixture was poured on 300 ml of water and acidified with Hydrobromic acid. The toluene layer was isolated, aqueous layer was extracted with diethyl ether, all organic liquids were combined, dried over anhydrous Magnesium Sulfate, evaporated and the dry residue recrystallized from Methylene Chloride.

2.2g of the prepared Bis(4-tert-butylphenyl) 4,4′-dibromobiphenyl-2,2′-disulfonate was mixed with 45 ml of tetrahydrofuran, 1g of anhydrous sodium carbonate, 0.99g of 2,2′-(1,4-phenylene)bis-(4,4,5,5-tetramethyl-1,3,2-dioxaborinane) and 70 mg of Tetrakis(triphenylphosphine) palladium (0). The reaction mass was heated with agitation and kept at 65° C. for 4 days. Then it was allowed to cool to room temperature and diluted with 300 ml of water. The precipitated polymer ester was isolated by filtration and hydrolyzed in mixture of NaOH and methanol. The resulting polymer was fully water soluble and formed nematic liquid crystal. The GPC molecular weight analysis of the sample was performed as described in Example 1.

### Examples of Optical Films

The polymers listed above can be used to form optical elements such as optical retarders, light collimators, light diffusers, light guides, optical fibers, lenses, LCD elements, optical security films, and various other optical films or components for optical elements or optical devices. Optical characteristics, such as refractive indices in each direction, are determined by types of polymers (e.g., their length and rigidity, conjugation along the polymer main chain), orientation of the polymers, and other factors. Specifically, optical characteristics may be controlled by selection of organic components (Core), side-groups (S), and the number of subunits (i.e., the value of n). As described above, by selecting these components and parameters, one may produce positive A-plates or like structures. In some embodiments, the birefringence of the deposited film is at least about 0.10 or, more specifically, between of about 0.10 and 0.30.

In an example, a polymer may be formed in a layer forming a plane in the X and Y directions. The X direction may be a coating direction. The layer may have a thickness in the Z direction. In some embodiments, the refractive index in the X direction (i.e., nₓ) may be greater than the refractive indices in the Y and Z directions (i.e., n_{y} and n_{z}). The refractive indices in the Y and Z directions (i.e., n_{y} and n_{z}) may be the same. This type of film may be referred to a positive A-plate. The refractive index in the X direction (i.e., nₓ) may be at least about 1.6, at least about 1.7, or even at least about 1.8. Very few conventional polymers have such high refractive indices. The refractive indices in the Y and Z directions (i.e., n_{y} and n_{z}) may be at least about 1.4 or, more specifically, at least about 1.5. For example, polymers for positive A-plates have been shown to have the refractive index in the X direction (i.e., nₓ) of 1.85 and the refractive indices in the Y and Z directions (i.e., n_{y} and n_{z}) of 1.57.

In some embodiments, the refractive index in the X direction (i.e., nₓ) may be greater than the refractive index in the Y direction (i.e., n_{y}), the latter of which is greater than the refractive index in the Z direction (i.e., n_{z}). In other words, the following condition is satisfied: n_{z}<n_{y}<nₓ. This type of film may be referred to as a Ac-type retarder (plate), which is more general case of positive A plate where nx>ny=nz. The refractive indices in the X direction (i.e., nₓ) may be at least about 1.7, at least about 1.8, or even at least about 2.0, while the refractive index in the Z direction (i.e., n_{z}) may be at least about 1.5, or, more specifically, at least about 1.6 or even at least 1.7. For example, polymers for positive A-plates have been shown to have refractive indices of about 1.85 in a coating direction (X-direction), while the refractive indexes are about the same and equal to about 1.58 in other two orthogonal directions (Y and Z).

### Deposition Methods

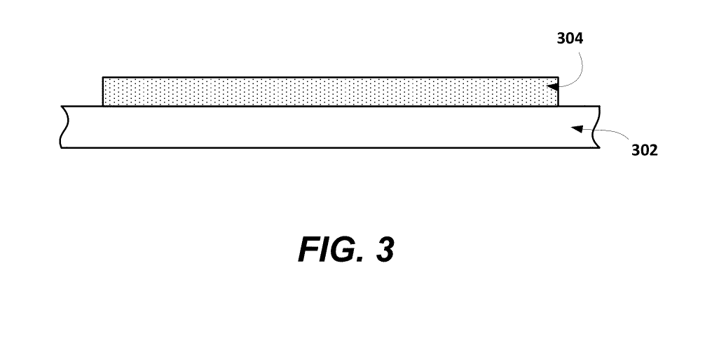

FIG. 3 is a high level illustration showing a substrate 302, one surface of which is coated with a polymer film 304. It should be clear to those skilled in the art that the polymer films 304 may be deposited onto both sides of the substrate 302. The substrate 302 may include, for example, a polymer substrate, glass substrate, TAC substrate, polypropylene substrate, polycarbonate substrate, acryl substrate, PMMA substrate, and so forth. The substrate 302 may have any suitable form and shape such as flat or having arched plates, or any other more or less complex form.

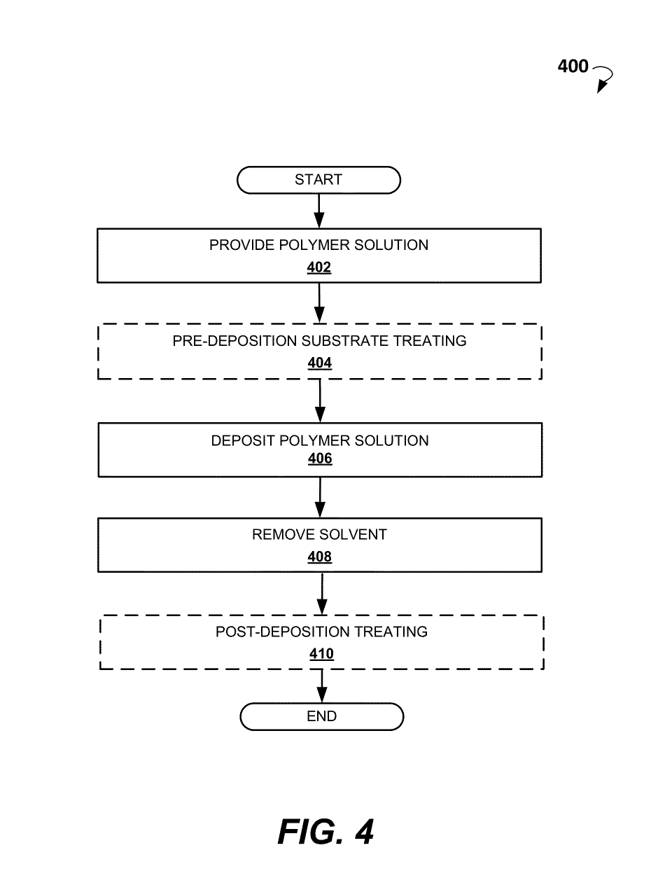

FIG. 4 shows a schematic illustration of a method 400 for depositing a polymer solution on a substrate 302, in accordance with various embodiments of the present disclosure. The method 400 may commence at operation 402 with providing a polymer solution. Various examples of polymers are described above which may include, generally speaking, water-soluble polymers, although water-insoluble polymers may be also utilized. Soluble polymers described herein may be dissolved in water or other solvents. In various embodiments, solvents may include water, ketones, hydroxyketones, alcohols, THF, monoethanolamine (MEA), and methylethylketone (MEK). In various embodiments, the polymer solution may include one or more additives such as nonylphenoxypoly glycidol, alcohols, acids, plasticizing agents, stabilizers, surfactants, antioxidants, and hindered phenol. The selection of the additives may depend on the particular polymers used, substrate type, and specific purposes.

The polymer solution may be characterized by a solid content, which is defined as a weight ratio of a polymer and other non-solvent components, if present, to the overall weight of the solution. The solid content may be varied to achieve a necessary viscosity and a shrinkage ratio between the wet and dry coating. For purposes of this document, the shrinkage ratio is defined as a ratio of two thicknesses, such as a thickness of the initial coated polymer solution before any drying occurs and a thickness of the fully dry polymer structure, i.e., the structure with the solid content of 100%. In some embodiments, a shrinkage ratio of some intermediate states may be used, such as between a partially dry state and a fully dry state. The solution may be also characterized by a polymer type, average molecular weight of the polymer and molecular weight distribution, temperature, and other characteristics. Some of these characteristics may be specific to a particular deposition technique.

In some embodiments, the substrate 302 may be pretreated at optional operation 404 to improve adhesion of the polymer to the substrate 302, to introduce cross-linking agents, and other purposes. Some examples of pretreating techniques may include cleaning of substrate 302, saponification, leaching, oxidizing, or modifying surface relief and/or free energy (e.g., by subjecting to corona discharge or plasma treatment). Various examples of pretreating procedures are given in the examples below.

At operation 406, the polymer solution is deposited onto one or more surfaces of the substrate 302 to generate a layer of polymer solution. The wet thickness of this layer may be selected based at least in part on desired dry thickness of the polymer. For example, the ratio of wet thickness to the desired dry thickness of the polymer film may be between about 5 and 20. It should be also noted that the polymer solution forms lyotropic liquid crystal prior to polymer deposition on the substrate.

In general, the polymer solution may be deposited using one or more of the following techniques: a slot die technique, spray technique, molding technique, roll-to-roll coating technique, Mayer rod coating technique, roll coating technique, gravure coating technique, micro-gravure coating technique, comma coating technique, knife coating technique, extrusion technique, printing technique, dip coating technique, and so forth. Some examples of these techniques are described in more detail below.

At operation 408, the solvent is removed from the polymer solution deposited onto the substrate 302. The solvent may be removed using one or more techniques including, for example, heating, drying, or subjecting to UV or IR light radiation. Some examples of these techniques are further described below.

At optional operation 410, one or more post-deposition treating techniques may be employed. The post deposition treating techniques may include cross-linking of organic units or shaping of the deposited polymer films. It should be understood that the sequence of operations 408 and 410 may be arbitrary. In certain embodiments, as shown in FIG. 4, the first solvent should be removed, and then a specific post-deposition process may be performed. In certain other embodiments, some post-deposition processes shall be performed first, and then the solvent may be removed. In yet other example embodiments, operations 408 and 410 are performed simultaneously. Furthermore, in yet other example embodiments, there may be several post-deposition operations 410 that are performed before operation 408 and right after operation 408. Those skilled in the art will appreciate that other example embodiments are possible as well. Below are provided various examples associated with operations 404-410.

### Examples of Pre-Deposition Substrate Treating Techniques

In various embodiments of the present disclosure, the substrate 302 may be subjected to a pre-deposition treatment to improve wettability and adhesion of a later deposited polymer film.

In one example of the pre-deposition treatment, a TAC substrate may be subjected to saponification by first rinsing the substrate with water, followed by dipping or coating the substrate with an aqueous solution of sodium hydroxide, followed by additional rinsing, and finally drying. The dipping operation may be between about 0.5 minutes and 5 minutes in duration or, more specifically, between about 1 minute and 3 minutes (for example, about 2 minutes). The aqueous solution may include between about 1% and 20% by weight of sodium hydroxide or, more specifically, between about 2% and 10%, such as about 6%. The solution may be kept at between about 20° C. to 90° C. or, more specifically, at between about 40° C. and 80° C., such as about 60° C. However, it should be noted that the temperature may vary during the saponification process and may depend on multiple criteria.

In another example of pre-deposition treatment, a glass substrate 302 may be subjected to an ultrasonic cleaning using a mildly alkaline water solution. For example, between about 0.1% and 10% by weight (e.g., about 1%) of DECONEX® 12-PA (available from Borer Chemie AG in Zuchwil, Switzerland) may be used for these purposes. The cleaning solution may be kept at a temperature of between about 20° C. and 40° C., such as about 30° C. The duration of the ultrasonic cleaning phase may be between about 0.5 hours and 24 hours or, more specifically, between 1 hour and 5 hours (such as about 2 hours). The glass substrate may be then subjected to soaking and washing with water before subjecting to leaching and oxidizing in an aqueous solution containing between about 1% and 20% by weight of sodium hydroxide or, more specifically, between about 2% and 15% (such as about 15%). The leaching and oxidizing may be performed in an ultrasonic bath for between about 5 minutes and 120 minutes or, more specifically, between about 10 minutes and 60 minutes (such as about 30 minutes). The glass substrate may be then rinsed and dried.

In yet another example of pre-deposition treatment, a thin layer of a primer may be deposited onto a substrate 302 prior to the deposition of a polymer solution layer. The dry thickness of the primer may be between about 10 nm and 200 nm or, more specifically, between about 20 nm and 100 nm (such as about 50 nm). For example, silane or polyethyleneimine may be used as primers. A water based polymer solution containing less than 10% by weight of primer or, more specifically, less than 2% (such as about 0.5%), may be used for this purpose.

Other pre-deposition substrate treatment techniques may include exposing a surface of substrate to corona discharge, coating a thin layer of a surfactant solution, coating a thin layer of alcohol, subjecting to electron beam, subjecting to ion beam, subjecting to plasma discharge, and so forth. In any case, the pre-deposition substrate treatment techniques may improve the substrate's adhesion and wettability properties.

### Examples of Deposition Techniques

Below are provided several examples of deposition techniques used for applying a layer of polymer solution onto a substrate 302. One having ordinary skills in the art would understand that some of these characteristics may be also applicable to other deposition techniques as well.

### Slot Die Extrusion Example

The slot die technique is generally suitable for depositing uniform layers having a thickness in the range of about 1 micron to about 2000 microns (wet), using solutions (or slurries) having viscosities of 1 cP to 100,000 cP and maintained at temperatures of up to 250° C., and using linear speeds of up to 500 meters per minute. The viscosity of the coated polymer may be controlled by molecular weight, solid content, additives, and temperature. Viscosity may impact flow characteristics of polymer solutions, and shear stresses applied to the forming film, and, as a result, the alignment of polymer molecules within a deposited layer and resulting optical characteristics of the layer. The polymer solution temperature, which may be referred to as a feeding temperature, may be between about 10° C. and 80° C. Below 10° C., the water gets closer to its freezing point, while temperatures above 80° C. may cause rapid evaporation and loss of water resulting in a system that may be difficult to control. Before deposition, it should be ensured that the polymer solution is homogeneous, which may be done by warming and/or stirring. At this step, one or more additives may be added to the polymer solution based on an application or certain tasks.

The provided solution is then deposited onto the substrate as a thin layer. As noted above, the polymer solution may be deposited onto a substrate or be formed into free-standing structures according to one or more embodiments described above. The thickness of the deposited layer may depend on one or more of the following: a substrate feed speed, substrate width, polymer solution feed rate, and solids content. The substrate feeding speed may be between 0.5 meters per minute and 500 meters per minute or, more specifically, between 2 meters per minute and 20 meters per minute. While faster speeds are beneficial from the process throughput perspective, the feeding speed may be controlled to achieve specific shear forces for redistributing and aligning polymer molecules within the deposited layer. The feeding rate of polymer solution may be between 1 gram per minute and 2500 grams per minute. In some embodiments, deposited film thickness may be between 10 microns and 2000 microns or, more specifically, between 25 microns and 250 microns. This is the thickness of the wet coating and changes substantially during drying. As noted above, the degree of change, i.e., the shrinkage ratio, depends on the solids content and other factors.

When the slot-die technique is used, slot die lips may be separated by a distance between 10 microns and 1000 microns or, more specifically, between 25 microns and 250 microns. The lip separation may determine pressure in the die and, therefore, film thickness uniformity. Additionally, the slot die is spaced relative to the substrate and allows the polymer solution to flow onto the substrate and be deposited as a uniform layer. In some embodiments, the gap between the slot die and the substrate is between 10 microns and 1000 microns or, more specifically, between 25 microns and 250 microns, and may be varied to control coating quality.

In order to better understand some equipment based parameters, such as spacer thicknesses, substrate feeding speed, and solution feeding rates, a brief description of the slot die coating system may be helpful. A slot die coating system may include five main components: a die, a die positioner, a roll, a fluid delivery system, and a substrate. The die determines the rate of polymer solution dispensing onto the substrate. The fluid rheology (e.g., viscosity, surface tension) is a contributing factor together with a design and position of the die. Some polymer based solutions have specific rheological properties that require specific design of the die, e.g., the internal flow geometry. The die manifold is the contoured flow geometry machined into the body sections of the die. The function of the die is to maintain the solution at the proper temperature for application, distribute it uniformly to the desired coating width, and apply it to the substrate. The manifold distributes the coating fluid that enters the die to its full target width and is designed to generate a uniform, streamlined flow of material through the exit slot of the die. The die positioner is an adjustable carriage that precisely positions the slot die at the optimum angle and proximity to the roll and isolates the die from vibrations that can affect coating application. The die positioner stabilizes the interaction between the die and the moving substrate, sets the angle of dispensing between the die and substrate, and sets the distance between the die and substrate. The roll provides a precisely positioned surface with respect to the die position and is used for supporting the substrate. The fluid delivery system is used to provide a constant feed of polymer solution into the die. The delivery system may determine the coat weighting weight and thickness of the deposited layer.

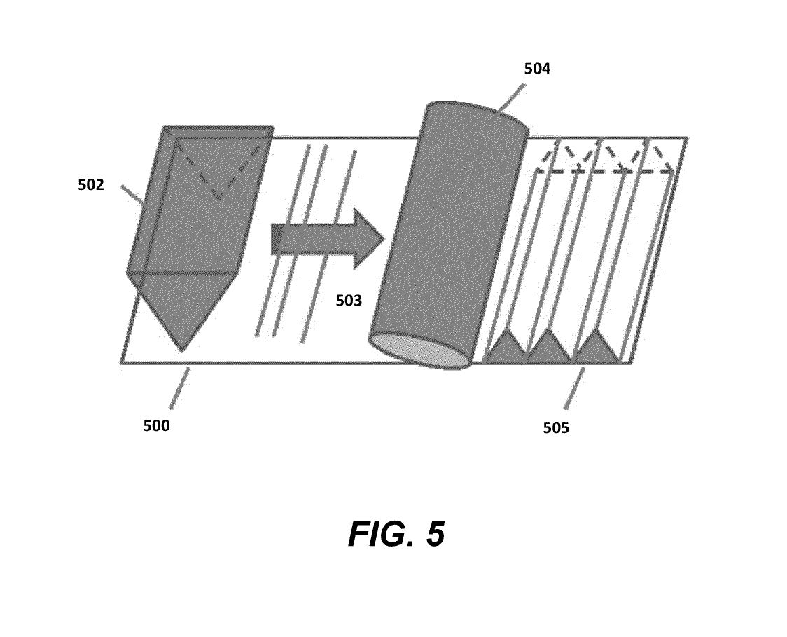

FIG. 5 illustrates an exemplary slot die 502 deposition technique that includes rolling an embosser roll 504 over the substrate 500 of a film in a coating direction 503. This technique results in a final structure 505 imprinted on the film.

### Roll-to-Roll Deposition Example

When a roll-to-roll technique is used (which is also known as web processing or reel-to-reel processing), a polymer solution may be deposited on a substrate presented in the form of a film. The deposition may be made using any suitable technique. In an example, the deposition may include the use of applicator, which may be adjusted by a shear force (a knife) on a moving substrate. The deposition may be performed such that further drying technique is applied, or UV cross-linking techniques are utilized as described below. Once the substrate film has been coated, it is rolled onto another roll and may be slit to a desired size on a slitter or be further processed to extrusion, embossing, subjected to high-temperature, or dipping in barium chloride or other salt solution (alone or combined), as further described below. In addition, it should be noted that the substrate film may be secured on a roll and rolled out at a predetermined rate such that the polymer solution may be delivered onto the substrate film with desired thickness.

As noted above, before deposition, homogeneity of the polymer solution should be ensured. The web speed and/or coating solution flow rate should be set so as to control desired shear stress and coating thickness. The polymer solution solids concentration and feed temperature should be also set.

In an example, the substrate was coated with the polymer solution to exhibit a positive A-plate behavior with in-plane retardation values (Rₒ) defined as:

Rₒ=thickness*(nₓ−n_{y})

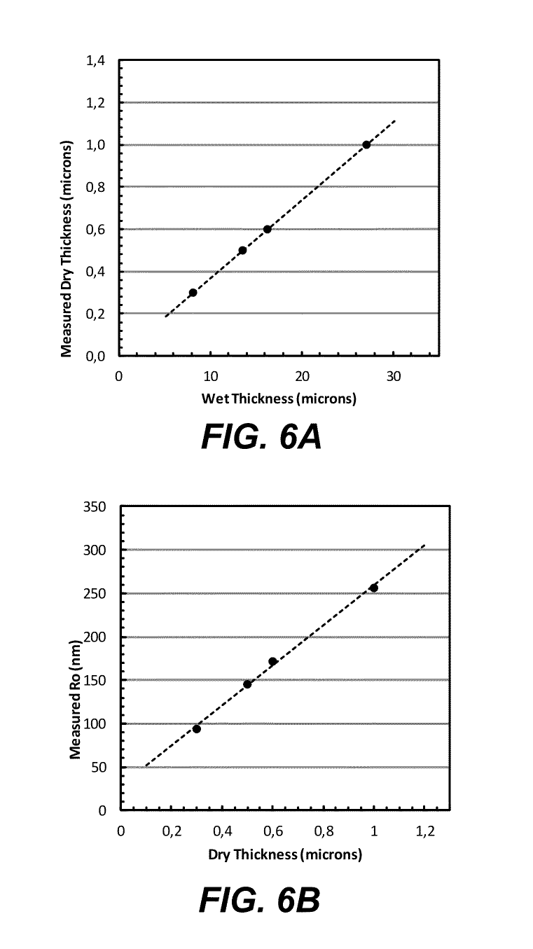

The Rₒ values may be controlled by dry coating thickness. Based on measurements, it can be predicted that the measured Rₒ relates linearly to the thickness of deposited a layer polymer compound described herein. Thus, the retardance may be controlled through the deposition conditions and characteristics. This is further illustrated in FIGS. 6A and 6B, which show dry thickness dependency against wet thickness (FIG. 6A) and retardation dependency against dry thickness (FIG. 6B).

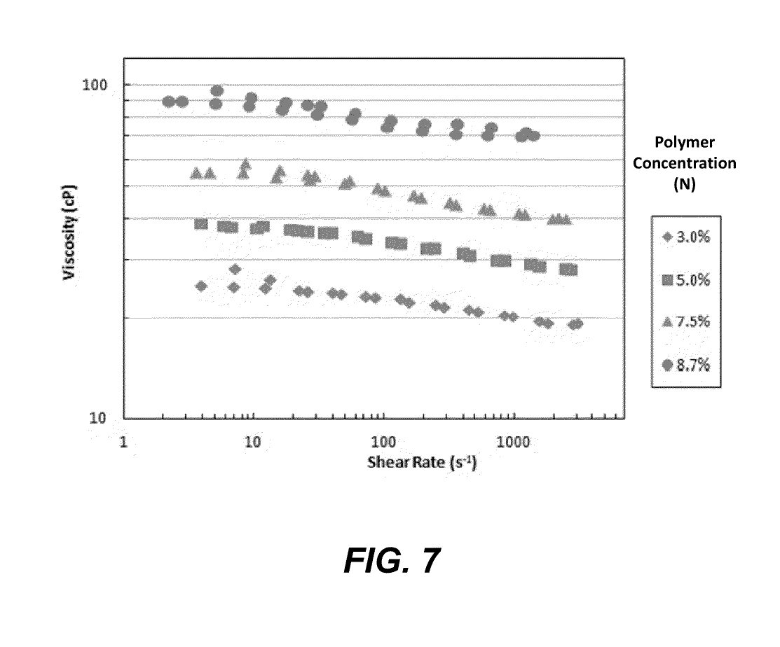

As already noted, the viscosity of the coated polymer solution may be controlled by various parameters such as a molecular weight, solids content concentration, temperature, and so forth. Shear stresses applied to the forming polymer solution film may also impact viscosity and flow characteristics of polymers solutions, and, as a result, the alignment of polymer molecules within a deposited layer and resulting optical characteristics of the optical layer. FIG. 7 shows measured dependencies of viscosity (cP) as a function of shear rate (s⁻¹) for different polymer concentrations (N).

### Molding Deposition Example

When a molding technique is used, a polymer solution may be delivered into a mold cavity that has one or more surfaces permeable to air and water vapor but not permeable to polymer molecules (e.g., because of their large sizes). The molds may be configured to produce lenses or other optical elements with specific physical optical properties such as refraction, aberrations, curvatures, and so forth.

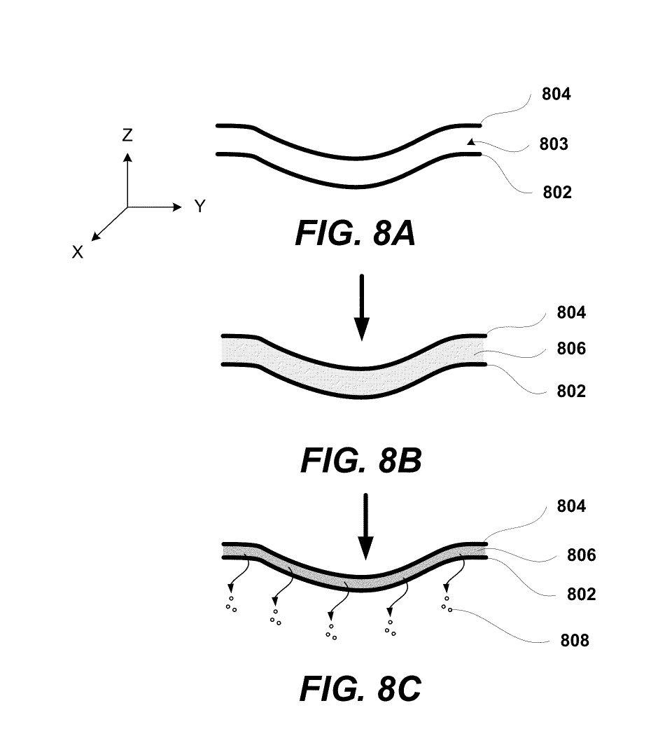

A sequence of molding operations is schematically illustrated in FIGS. 8A-8C. Specifically, FIG. 8A illustrates a mold 800 having a first surface 802 and a second surface 804. First surface 802 and second surface 804 form a cavity 803 for receiving a polymer solution. The spacing between first surface 802 and second surface 804 may be initially (i.e., during the receiving of the polymer solution) greater that the side of the final polymer structure in order to accommodate for shrinking during drying. In some embodiments, the first surface 802 and second surface 804 are movable with respect to each other to follow and control the profile of the drying (and shrinking) polymer.

FIG. 8B illustrates the mold 800 with polymer solution 806 disposed into the cavity. The polymer solution 806 may be injected into the cavity, while the cavity is maintained in a certain initial closed configuration. The internal volume of the cavity determines the amount of the polymer solution that can be provided into the mold 800. In another example, the cavity 803 may be initially open and the polymer solution may be initially supplied onto one surface of the mold 800 (e.g., the first surface 802), while another surface (e.g., the second surface 804) then engages and displaces some polymer solution out of the cavity, thereby ensuring that the entire cavity is filled with the polymer solution. Unlike the conventional injection molding in which a thermoplastic polymer is melted and supplied into a mold in its melted state, polymer solution 806 may be supplied at relatively low temperatures, e.g., between about 40° C.-250° C. to prevent degradation of polymers. The viscosity of the polymer solution may be controlled by the solids content as described above with reference to the slot die coating.

One or both surfaces 802 and 804 may be permeable to water vapor so that the water vapor can escape from mold 800 during drying of the polymer solution. However, the surfaces 802 and 804 still retain polymer molecules within the mold. For example, one or both surfaces 802 and 804 may have micro-holes. One or both surfaces 802 and 804 may be heated to between about 100° C. and 250° C. to expedite drying and evaporation of the solvent from the polymer solution.

As the solvent leaves the mold 800, the thickness of the polymer solution inside the mold 800 may reduce. In order to avoid empty cavities within the mold 800, surfaces 802 and 804 may be configured to move towards each other in the direction shown in FIG. 8C. The position of surfaces 802 and 804 may be used to control drying of the polymer solution (e.g., the amount of heat supplied surfaces 802 and 804 or, more specifically, temperatures of surfaces 802 and 804). This feedback may be used to prevent excessive or inadequate drying.

It should be also noted that the surfaces 802, 804 may have a specific shape, form, or design. For example, the surfaces 802, 804 may be of a hemi-spherical shape so as to form a lens or similar device. The surfaces 802, 804 may also have specific design so as to form, for example, Fresnel lens like devices.

### Examples of Removing Solvent Technique

Returning now to FIG. 4, at operation 408, solvent is removed from the deposited polymer solution. The solvent may be removed by drying at temperatures of at least about 80° C. The upper limit is generally determined by the stability of the polymer used in the solution. These temperatures may represent the actual temperature of the material during its drying or the temperature of surrounding components, such as the temperature of the substrate, the temperature of atmosphere over the surface of the material, and the like. The drying may be also performed by blowing drying gas at specific temperatures. For example, the drying gas may include nitrogen or heated air. In general, higher temperatures are preferred to expedite the drying process. However, fast removal of water may disturb the arrangement of polymer molecules within the drying structure and distort optical properties.

In certain example embodiments, the drying process may include multiple steps. For example, the drying by heating may also include subsequent cooling of the polymer solution. In various embodiments, one or more drying devices may be utilized such as flash dryers, rotary dryers, spray dryers, fluidized bed dryers, vibrated fluidized beds, contact fluid-bed dryers, plate dryers, and so forth.

### Examples of Post-Deposition Treating Techniques Shaping

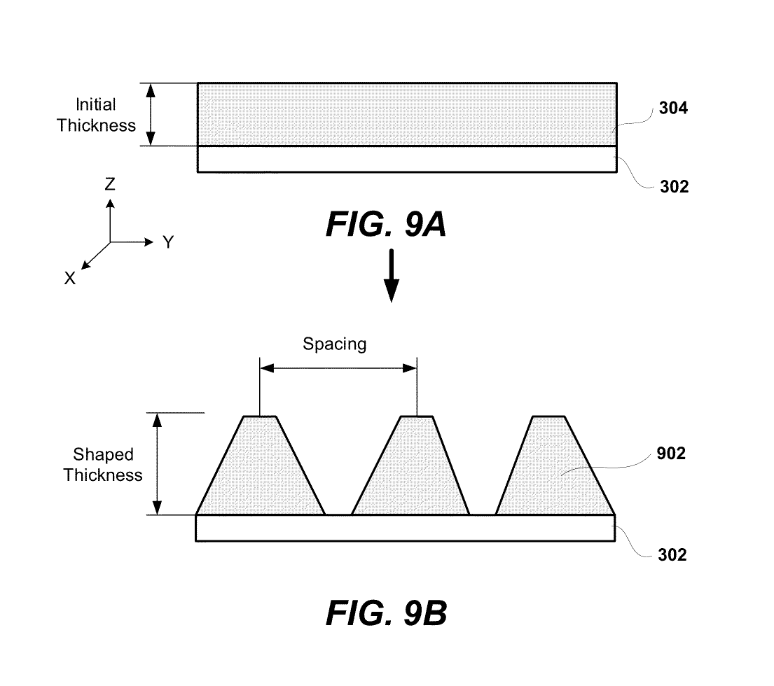

In various embodiments, post-deposition treating operation 410 may involve shaping of the polymer solution layer. For example, a polymer solution layer may be embossed to form grooves, for example, as shown in FIGS. 9A and 9B. Specifically, in FIG. 9A there is shown a substrate 302 having a polymer solution layer 304 deposited on top thereof. FIG. 9B shows the result of grooving of the polymer solution layer 302, namely shaped polymer coating 902. Shaping of the polymer solution layer may be performed on a fully dried polymer structure (i.e., the solids content of about 100%), on a partially dried polymer structure, or on a deposited polymer coating before any drying occurs. In the latter two cases, the shaping device (e.g., an embossing roll) may need to accommodate for subsequent changes in thickness. As such, the tolerance of the shaping devices used in these cases may not need to be as precise as for the device used on a fully drier polymer structure.

Shaping of the polymer structures (regardless of their drying state) may be performed while the polymer structures are kept between about 50° C. and 200° C. The shaping tool may be also heated to this temperature range. In some embodiments, the shaping tool is heated to between about 100° C. and 200° C. while the polymer structures may be maintained at the same temperature or lower temperature prior to contacting the shaping tool. One having ordinary skills in the art would understand that some drying may occur at these conditions if the polymer structures still have solvent. In some embodiments, some drying is performed after the polymer structure is shaped. This post-shaping drying may be performed in addition to pre-shaping drying.

In yet another example, the solid content of the dry polymer can be reduced by adding solvent. This may be done in order, for example, to reshape the polymer. Furthermore, the fully or partially dry polymer may be extruded into fibers and hollow tubes. Unlike conventional extrusion in which thermoplastic polymers are heated to make them conformal, water can be added to the water soluble polymers before shaping or extrusion.

### Cross-Linking

The post-deposition treating operation 410 may involve cross-linking of polymer chains using UV light radiation, IR light radiation, or other types of activation energy sources such as electron, ion, or gamma radiation. The cross-linking may involve forming links between two or more adjacent polymer molecules and/or extending polymer molecules by linking end groups. Examples of UV sensitive groups responsible for cross-linking may include carbon double bonds and carbon triple bonds. The groups may be introduced into some or all monomers during their synthesis. The groups may be relatively inactive during coating and partial or even entire drying operations but capable of activating after coating and, in some embodiments, after partial or complete drying. In various example embodiments, UV light radiation may have wavelengths, for example, of about between about 180 nanometers and 400 nanometers.

One example of UV cross-linking will now be described in more detail. A polymer shown below may be formed into a positive A-plate. When a deposited polymer film is subjected to UV light irradiation, the irradiated polymer film becomes less soluble before any further post-treatment, such as exposing to metal cations for cross-linking. Without being restricted to any particular theory, it is believed that double bonds present in each polymer molecule react under UV-irradiation forming inter-molecular bonds with adjacent molecules. Below is shown an example cross-linking of polymers having derivative structural formulas (VIII), (XIII):

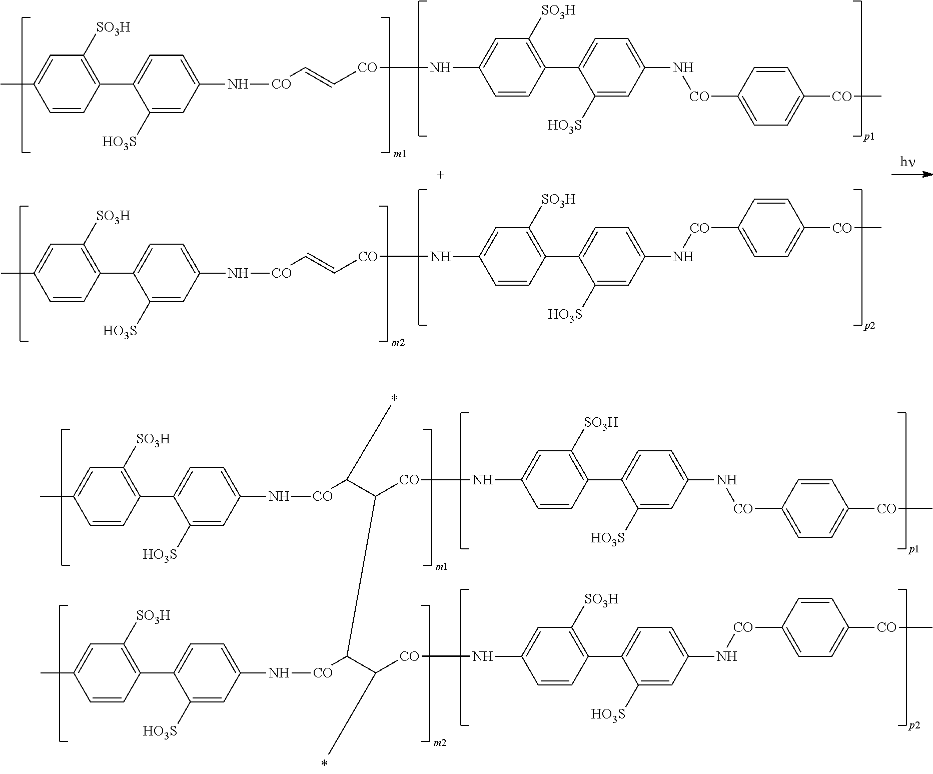

Asterisks as shown above designate continuations of the polymeric chains. Even though these asterisks are shown in 2D to continue into two directions, they can also continue in three directions in 3D.

Another example is presented by the formula below. The polymer uses chain terminators to control the molecular weight. Without these chain terminators, the material may extend to a molecular weight of 220,000 units and become insoluble. With the chain terminators, the molecular weight may be reduced to about 20,000 units and has sufficient solubility. These chain terminators may be UV-curable groups (e.g., C═C double bonds, or even triple bonds) that could be easily activated to increase the molecular weight in the film after coating, in order to provide a 3D network and to reduce solubility. This example is further illustrated by the following structural formulas:

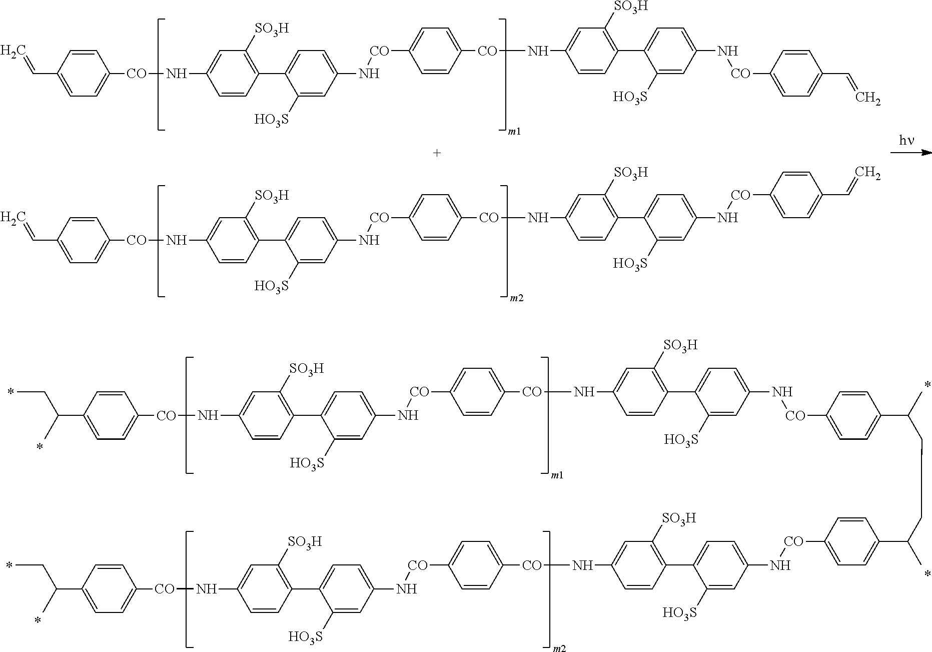

Asterisks as shown above designate continuations of the polymeric chains.

### Conversion of Polymer Films into Water-Insoluble Form

In some embodiments, method 400 (FIG. 4) may involve a post-deposition treatment of the polymer layer with a solution of a water-soluble inorganic salt having one or more of the following cations: H⁺, Ba²⁺, Pb²⁺, Ca²⁺, Mg²⁺, Sr²⁺, La³⁺, Al⁺, Bi³⁺, Zn²⁺, Zr⁴⁺, Ce³⁺, Y³⁺, Yb³⁺, Gd³⁺, and any combination thereof. For example, a dry polymer layer may be dipped or otherwise come in contact with one or more of the following: barium chloride, barium nitrate, lanthanum chloride, lanthanum nitrate, aluminum salt, and so forth.

In certain embodiments, a dry polymer layer may be dipped or otherwise come in contact with a barium nitrate (Ba(NO₃)₂), barium chloride (BaCl₂), or lanthanum chloride (LaCl₃), or stronsium chloride, aluminum chloride, or other salt—water based solution such as for example bismuth chloride or bismuth acetate e.g. AlCl₃, LaCl₃, SrCl₃, BiCl₂, or BiCOOH, or even calcium salts. The concentration of barium nitrate or above equivalent in water may be between about 2% and 20% by weight or, more specifically, between 5% and 15% (such as about 8.5% by weight). For example, 87.55 g of anhydrous barium nitrate may be dissolved in 942.45 g of water. The duration of the dry polymer layer with the post-treatment solution may be between about 0.1 seconds and 10 seconds or, more specifically, between about 0.5 seconds and 5 seconds (such as between about 1 second and 2 seconds). After this exposure to the salt solution, the polymer layer is rinsed with water and dried. In a roll-to-roll deposition operation, the substrate may be passed through a bath containing the post-treatment solution and through the bath containing water and followed by drying. In some embodiments, the post-treatment solution may be applied as a coating over the dry polymer layer using for example slot die or spray techniques to better control distribution of the post-treatment solution. The substrate may be then sprayed with the water to rinse off the post-treatment solution and then be dried. This method avoids exposure of the back side of the substrate to any residual salts. In some embodiments, one or more operations described above are repeated one or more times using the same solutions.

### Examples of Optical Elements

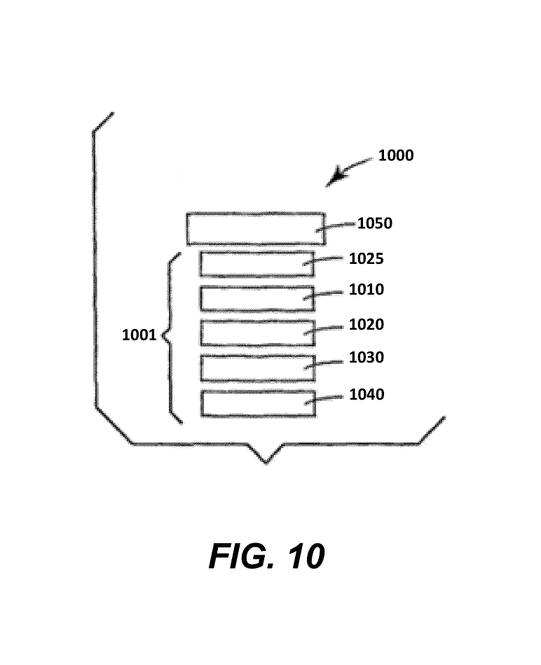

FIG. 10 illustrates a schematic cross-sectional view of one illustrative display system 1000 including a light modulator 1050 disposed on an optical compensator stack 1001 that includes a j-retarder 1010 disposed on a first liquid crystal layer 1020. The j-retarder 1010 includes a layer of polymeric film being substantially non-absorbing and non-scattering for at least one polarization state of visible light. The j-retarder 1010 has x, y, and z orthogonal indices of refraction where at least two of the orthogonal indices of refraction are not equal, with an in-plane retardance being 100 nm or less and an absolute value of an out-of-plane retardance being 50 nm or greater. The first liquid crystal layer 1020 includes liquid crystal material. The first liquid crystal layer 1020 may be A-plate or the like. The optical compensator stack 1001 may include a second liquid crystal layer 1025 disposed on the j-retarder 1010 or the j-retarder 1010 can be disposed between the second liquid crystal layer 1025 and the first liquid crystal layer 1020. The optical compensator stack 1001 may further include a polarizer layer 1030 disposed on the first liquid crystal layer 1020 or the first liquid crystal layer 1020 can be disposed between the polarizer layer 1030 and the j-retarder 1010. The polarizer layer 1030 may be an absorbing polarizer or a reflecting polarizer. A reflecting polarizer layer 1040 can be disposed on the polarizing layer 1030 or the polarizing layer 1030 can be disposed between the reflecting polarizing layer 1040 and the first liquid crystal layer 1020.

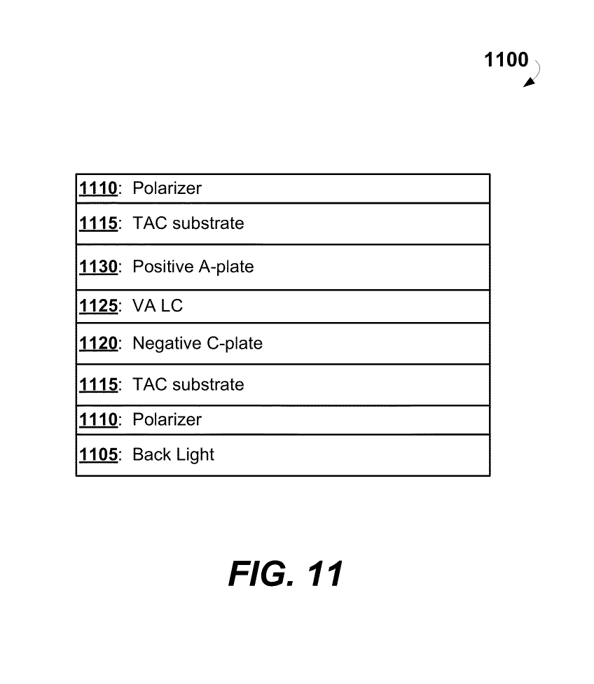

FIG. 11 illustrates schematic cross-sectional view of example display system stack 1100. In FIG. 11, there is shown the stack 1100 including a back light unit 1105, two polarizers 1110, two substrates 1115 (e.g., TAC substrates) having the thickness of about 80 micrometers, a negative C-type retardation layer 1120 (C-plate), Alignment (VA) liquid crystal (LC) layer 1125, and a positive A-type retardation layer 1130 (A-plate). The VA LC layer 1125 may have a thickness of about 20 micrometers. The positive A-plate 1130 and negative C-plate 1120 are created using the techniques described herein. The retardation layers 1120, 1130 may have the thickness of about 3 micrometers or even less. The overall thickness of the stack 1100 may be of about 200 micrometers.

Further, for the design shown in FIG. 11, simulation tests have been performed with respect to finding optimized thicknesses and viewing angle contrast ratios. The simulation results presented herein were received for two orientations of the fast principal axes of the positive A-type retarder: i) φ=0° and ii) φ=90°. Only these two orientations of positive A-type retarder do not influence the field-off black state of the VA design at the normal light incidence.

With reference to FIG. 11, the principal axes are defined as follows. The z-axis of the laboratory xyz frame is taken to be along the normal to the layers, and it is directed from the back light source. The x and y axes are mutually orthogonal and parallel to planes of the elements. The rear (input) polarizer transmission axis is taken to be aligned along the x-axis (φ=0°, while the front (output) polarizer axis is at azimuth angle φ=90° counted with respect to the x-axis in the xy plane. The LC director field-induced reorientation plane (defined by LC alignment plane defined by the easy axes and the normal) is at φ=45° or at φ=−45° (two types of the domains have been simulated).

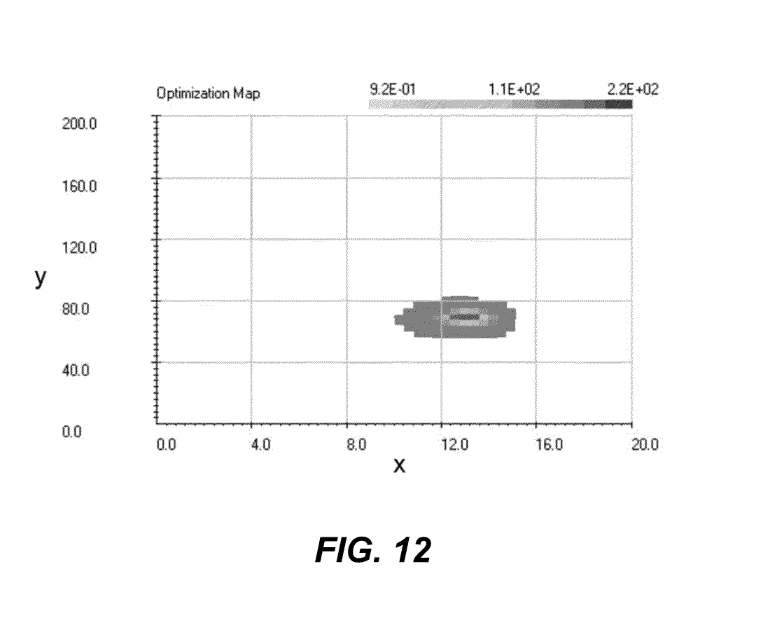

FIG. 12 shows an optimization plot (map) for the stack 1100 illustrating thickness of C-plate 1120 and A-plate 1130. In this plot, x-axis is for the thickness (given in micrometers) of negative C-plate 1120 with birefringence Δn=0.01, while y-axis is for the thickness (given in micrometers) of positive A-plate 1130 (Zeonor film with the birefringence Δn=0.00158). The plot is for φ=+45° VA LC layer 1125, φ=−45° azimuth of the incidence plane of the light beam and for φ=75° of the incidence angle (viewing angle).

According to the optimization map, the optimal design is achieved at a Zeonor film thickness of 69 micrometers (retardation 109 nanometers). The retardation of negative C-plate 1120 should be 130 nanometers.

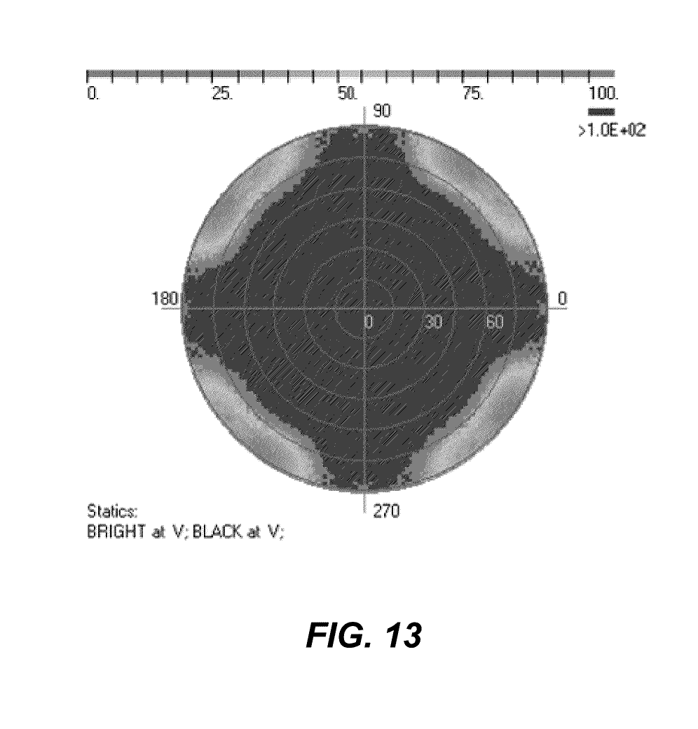

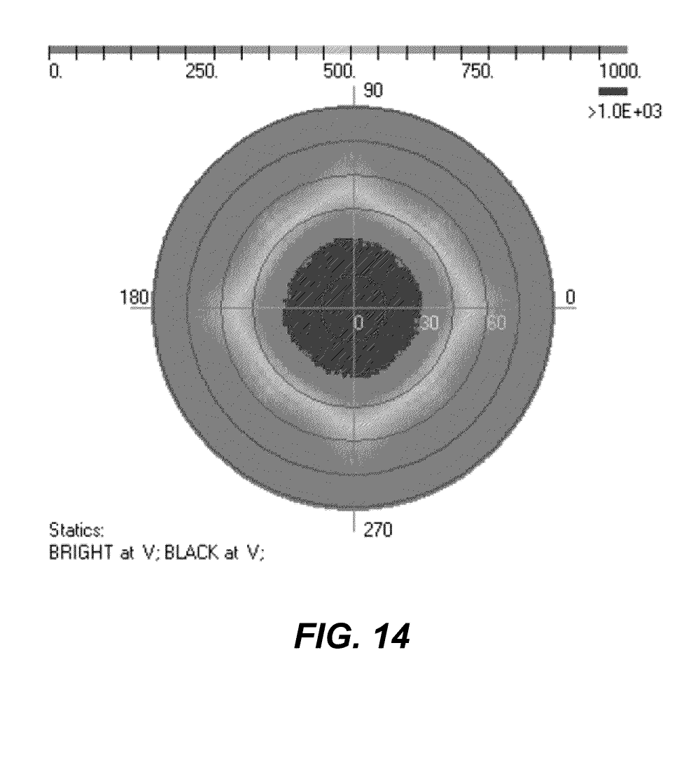

FIG. 13 shows a viewing angle contrast ratio diagram. In particular, FIG. 13 shows a viewing angle contrast ratio map for φ=+45° in the case of the optimized design in accordance with the map shown in FIG. 12. FIG. 14 shows the same viewing angle contrast ratio diagram, but for contrast ratio (CR) level of 1000:1.

In FIGS. 13 and 14, we can see that the contrast ratio of 100:1 is achieved for all possible azimuth angles in a viewing angle (φ) sector ±75°. Even at extreme viewing angles (φ) close to ±90° with respect to the normal, the contrast ratio is of about 50:1. Also, for all the possible azimuth angles, the CR value is higher than 500:1 in a viewing angle (φ) sector ±50°. These data have been used to produce elements of the optimized display system stack 1100.

### Example 8

Example 8 shows adhesion of the polymer solution to the PMMA substrate. The test results are presented in Table 1 below.

TABLE 1

| | Environment Exposure | Film remaining |
|---|---|---|
| # | Time, hours | adhered, % |
| 1 | 0 | 100 |
| 2 | 80 | 100 |
| 3 | 200 | 100 |
| 4 | 400 | 100 |
| 5 | 600 | 99 |
| 6 | 800 | 87 |
| 7 | 1000 | 100 |

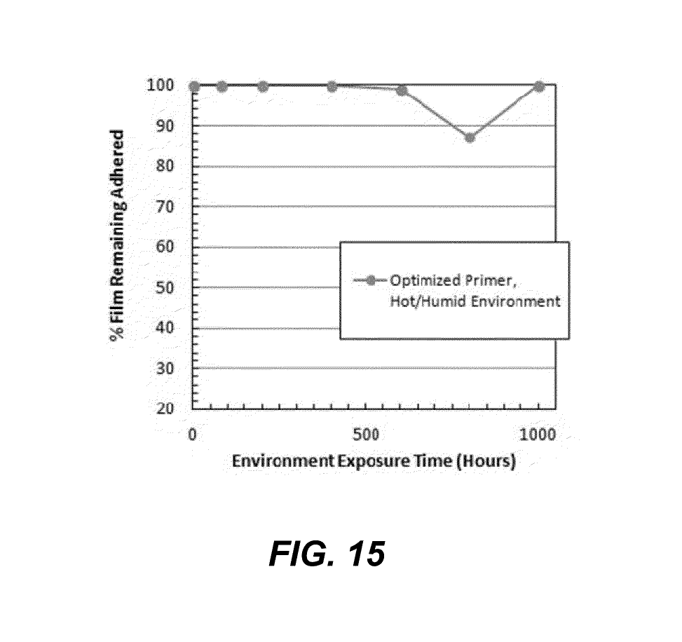

FIG. 15 illustrates results of the adhesion test shown in Table 1. As can be seen in FIG. 15, the polymer demonstrated substantially 100% adhesion to the PMMA substrate.

In numerous tests the polymer demonstrated the same substantial 100% adhesion to other substrates, such as TAC and PC.

### CONCLUSION

Thus, new organic polymer compounds suitable for forming positive A-type retarders, as well as methods of production thereof, have been disclosed. Although the foregoing concepts have been described in some detail for purposes of clarity of understanding, it will be apparent that certain changes and modifications may be practiced within the scope of the appended claims. It should be noted that there are many alternative ways of implementing the processes, systems, and apparatuses disclosed herein. Accordingly, the present embodiments are to be considered as illustrative and not restrictive.

1. A polymer compound comprising n organic units having the following structural formula:
[-(Core(L)ₘ)ₖ-G₁-]ₙ,
wherein the organic units comprise rigid conjugated organic component Core capable of forming rod-like macromolecules, wherein G is a spacer selected from the group consisting of —C(O)—NR1-, —O—NR1-, linear and branched (C1-C4)alkylenes, —CR1R2-O—C(O)—CR1R2-, —C(O)—O—, —O—, and —NR1-, wherein R1 and R2 are independently selected from the group consisting of H, alkyl, alkenyl, alkynyl, and aryl; wherein L are lyophilic side-groups providing solubility to the polymer in a solvent and which are the same or different and independently selected from the group consisting of —COOX, —SO₃X, wherein X is selected from the group consisting of H, alkyl, alkenyl, alkynyl, aryl, alkali metal, and NW₄, wherein W is H or alkyl or any combination thereof, —SO₂NP1P2 and —CONP1P2, wherein P1 and P2 are independently selected from the list comprising group consisting of H, alkyl, alkenyl, alkynyl, and aryl; and wherein m is 0, 1, 2, or 3, and wherein k is 1, 2, or 3; and
wherein the number n provides a molecule anisotropy that promotes self-assembling of macromolecules in a solution of the polymer, thereby forming a lyotropic liquid crystal.

2. (canceled)

3. The polymer compound of claim 1, wherein the solvent comprises one or more of the following: polar protic solvent, polar aprotic solvent, and non-polar solvent.

4. The polymer compound of claim 1, wherein the solvent comprises one or more of the following: water, ketone, alcohol, tetrahydrofuran, ester, an alkaline aqueous solution, dimethylsulfoxide, dimethylformamide, dimethylacetamide, and dioxane.

5. The polymer compound of claim 1, wherein the number n is at least 10.

6. The polymer compound of claim 1, wherein the conjugated organic components Core include polymeric main rigid-chains.

7. The polymer compound of claim 1, wherein the conjugated organic components Core include copolymeric main rigid-chains.

8. The polymer compound of claim 1, wherein at least one of the conjugated organic components Core is different from the remaining of conjugated organic components Core.

9. The polymer compound of claim 1, wherein the polymer includes a copolymer having two or more types of monomeric units.

10. The polymer compound of claim 1, wherein the n organic units further include one or more termination components connecting to the n organic units according to the following formula:
T-[-(Core(L)ₘ)ₖ-G₁-]ₙ-T,
wherein T includes one or more of alkenyl, alkynyl, and acrylic.

11. The polymer compound of claim 1, wherein the conjugated organic component Core includes one or more of the following structural formulas: 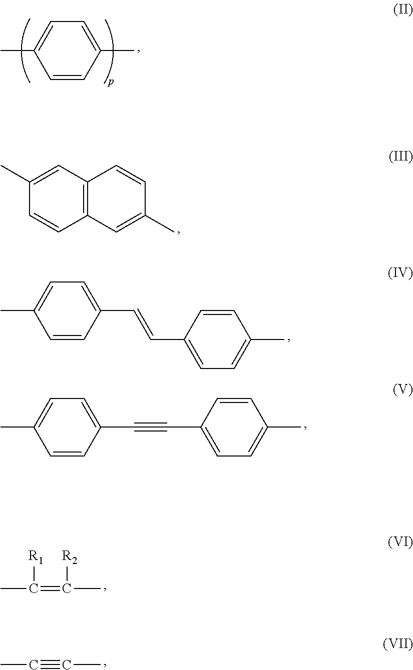
wherein p is an integer equal to 1, 2, 3, 4, 5, or 6 and R₁, R₂—═H, alkyl.

12. The polymer compound of claim 1, further comprising one or more additives, wherein the additives are selected from a group consisting of: surfactant, alcohol, acid, plasticizing agent, stabilizer, and antioxidant.

13. An optical film comprising:
a substantially transparent substrate having at least one surface;
at least one solid optical retardation layer formed on the at least one surface of the substantially transparent substrate;
wherein the at least one solid optical retardation layer includes a polymer compound comprising n organic units having the following structural formula:
[-(Core(L)ₘ)ₖ-G₁-]ₙ,
wherein the organic units comprise rigid conjugated organic component Core capable of forming rod-like macromolecules, wherein G is a spacer selected from the group consisting of —C(O)—NR1-, —O—NR1-, linear and branched (C1-C4)alkylenes, —CR1R2-O—C(O)—CR1R2-, —C(O)—O—, —O—, and —NR1-, wherein R1 and R2 are independently selected from the group consisting of H, alkyl, alkenyl, alkynyl, and aryl; wherein S are lyophilic side-groups providing solubility to the polymer in the solvent and which are the same or different and independently selected from the group consisting of —COOX, —SO₃X, wherein X is selected from the group consisting of H, alkyl, alkenyl, alkynyl, aryl, alkali metal, alkaline earth metal, Aluminum, Lanthanide, Bismuth, and NW₄, wherein W is H or alkyl or any combination thereof, —SO₂NP1P2 and —CONP1P2, wherein P1 and P2 are independently selected from the group consisting of H, alkyl, alkenyl, alkynyl, and aryl; and wherein m is 0, 1, 2, or 3; wherein k is 1, 2, or 3; wherein n is in the range of about 10 to about 10,000; and wherein the number n provides a molecule anisotropy that promotes self-assembling of macromolecules in a solution of the polymer forming thereby a lyotropic liquid crystal; and
wherein the at least one solid optical retardation layer is a solid optical retardation layer of positive A-type retarder substantially transparent to electromagnetic radiation in a visible spectral range.

14. The optical film of claim 13, wherein the organic units are the same.

15. The optical film of claim 13, wherein at least one of the organic units is different from others.

16. The optical film of claim 13, wherein the conjugated organic component Core includes one or more of the following structural formulas: 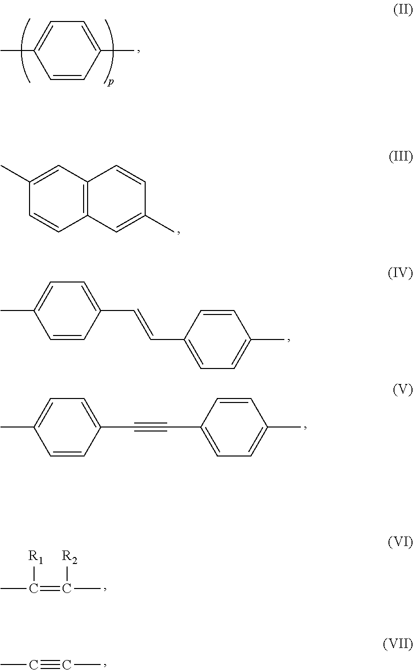
wherein p is an integer equal to 1, 2, 3, 4, 5, or 6 and R₁, R₂—═H, alkyl.

17. The optical film of claim 13, wherein birefringence of the at least one solid optical retardation layer is between about 0.1 and 0.3.

18. The optical film of claim 13, wherein the at least one solid optical retardation layer has a refractive index at least at one film direction of greater than about 1.6.

19. The optical film of claim 13, wherein the at least one solid optical retardation layer possesses refractive indices nₓ, n_{y} and n_{z} corresponding to x, y, and z axes of Cartesian coordinate system associated with the at least one solid optical retardation layer, wherein the x and y axes substantially coincide with the at least one surface of the substrate, and wherein n_{z} is smaller than nₓ and n_{y}, and wherein nₓ is greater than n_{y}.

20. The optical film of claim 19, wherein n_{z} is at least 1.5, and nₓ is at least 1.8.

21. A method for producing an optical retarder, the method comprising:
providing a polymer solution, the polymer solution comprising a solvent and a polymer, wherein the polymer comprises n organic units having the following structural formula:
[-(Core(L)ₘ)ₖ-G₁-]ₙ,
wherein the organic units comprise rigid conjugated organic component Core, wherein G is a spacer selected from the group consisting of —C(O)—NR1-, —O—NR1-, linear and branched (C1-C4)alkylenes, —CR1R2-O—C(O)—CR1R2-, —C(O)—O—, —O—, and —NR1-, wherein R1 and R2 are independently selected from the group consisting of H, alkyl, alkenyl, alkynyl, and aryl; wherein L are lyophilic side-groups providing solubility to the polymer in the solvent and which are the same or different and independently selected from the group consisting of —COOX, —SO₃X, wherein X is selected from the group consisting of H, alkyl, alkenyl, alkynyl, aryl, alkali metal, and NW₄, wherein W is H or alkyl or any combination thereof, —SO₂NP1P2 and —CONP1P2, wherein P1 and P2 are independently selected from the group consisting of H, alkyl, alkenyl, alkynyl, and aryl; and wherein m is 0, 1, 2, or 3, and wherein k is 1, 2, or 3, wherein n is in the range of about 10 to about 10,000; and wherein the number n provides a molecule anisotropy that promotes self-assembling of macromolecules in a solution of the polymer forming thereby a lyotropic liquid crystal;
depositing a layer of the polymer solution on a surface of a substrate, wherein a wet thickness of the layer of the polymer solution is selected based at least in part on a desired dry thickness; and
removing the solvent from the polymer solution to form a dry polymer layer of positive A-type retarder substantially transparent to electromagnetic radiation in a visible spectral range.

22. The method of claim 21, further comprising cross-linking the two or more of the n organic units.

23. The method of claim 22, wherein the crosslinking is accomplished by crosslinking agent B in the following formula: 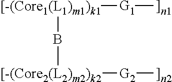
wherein Core1 and Core2, L1 and L2, m1 and m2, k1 and k2, G1 and G2, n1 and n2 are same or different.

24. The method of claim 22, wherein the crosslinking is accomplished by crosslinking agent B in the following formula:
T−[(Core₁(L)ₘ₁)ₖ₁-G₁-]ₙ₁−T+B+T−[(Core₂(L)ₘ₂)ₖ₂-G₂-]ₙ₂−T→T−[(Core₁(L)ₘ₁)ₖ₁-G₁-]ₙ₁−T−B−T−[(Core₂(L)ₘ₂)ₖ₂-G₂-]ₙ₂
wherein Core1 and Core2, L1 and L2, m1 and m2, k1 and k2, G1 and G2, n1 and n2 are same or different, and wherein T groups are selected from one or more of the following groups: alkenyl, alkynyl, and acrylic.

25. The method of claim 22, wherein the cross-linking of the two or more of the n organic units is performed according to the following reaction:

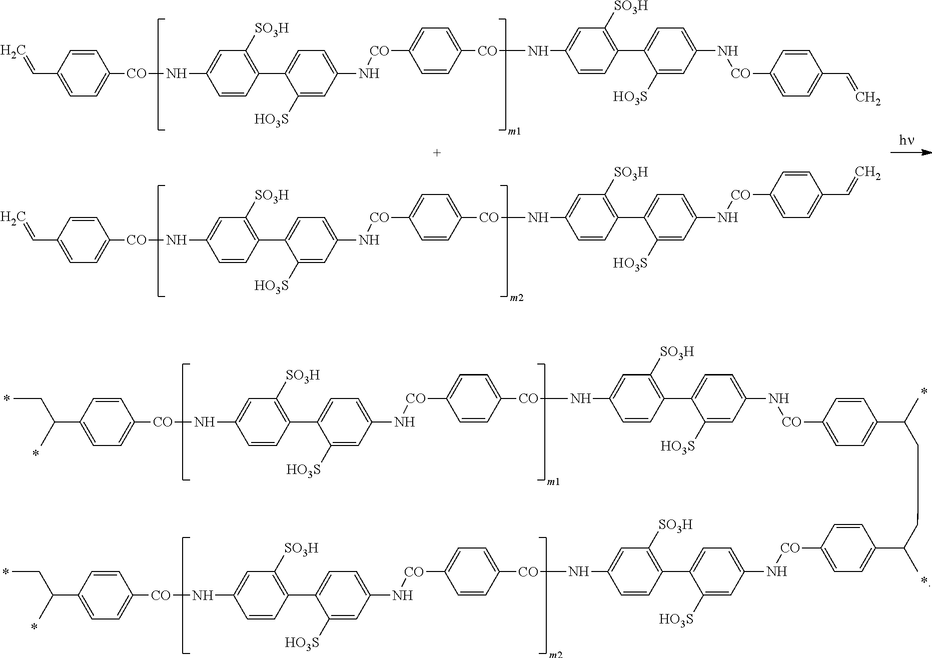

26. The method of claim 22, wherein the cross-linking of the two or more of the n organic units is performed according to the following reaction:

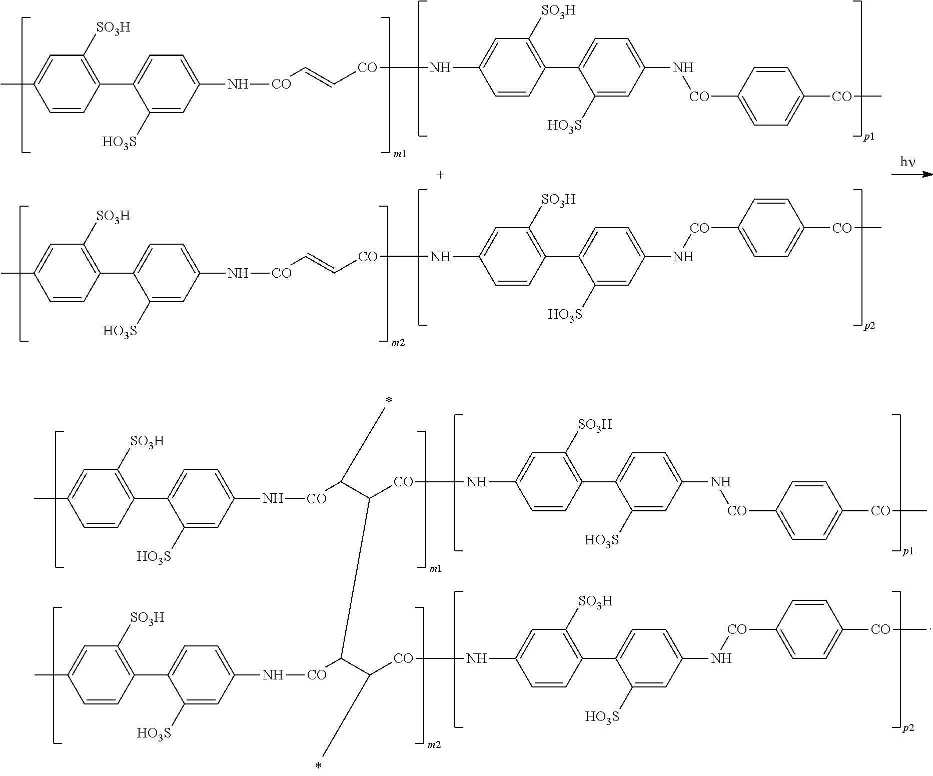

27. The method of claim 22, wherein the cross-linking includes one or more of the following processes: ultraviolet light radiating of the polymer solution, infrared light radiating of the polymer solution, radiating of the polymer solution with an electron beam, radiating of the polymer solution with an ion beam, and radiating of the polymer solution with a gamma beam.

28. The method of claim 21, wherein the removing of the solvent from the polymer solution includes one or more of the following processes: heating the polymer solution to at least 80° C., drying the polymer solution by subjecting to a drying gas flow, and drying the polymer solution using infrared light radiation or ultraviolet light radiation.

29. The method of claim 21, wherein the depositing of the layer of the polymer solution includes one or more of the following techniques: slot die extrusion, Mayer rod coating, roll coating, gravure coating, micro-gravure coating, comma coating, knife coating, extrusion, printing, spray coating, and dip coating.

30. The method of claim 21, wherein concentration of polymer in the polymer solution is between about 0.1% and 30% by weight.

31. A polymer solution comprising a polymer compound of claim 1 and a solvent, wherein the polymer solution is a lyotropic liquid crystalline polymer solution, and wherein the polymer solution is capable of being aligned by shear force and forming a solid optical retardation layer of positive A-type substantially transparent to electromagnetic radiation in a visible spectral range.
